(19) United States
(12) Patent Application Publication
(10) Pub. No.: US 2014/0321118 A1
(43) Pub. Date: Oct. 30, 2014

(54) LIGHTING DEVICE

(71) Applicant: Enplas Corporation, Saitama (JP)

(72) Inventor: Masato Nakamura, Saitama (JP)

(73) Assignee: Enplas Corporation, Saitama (JP)

(21) Appl. No.: 14/353,341

(22) PCT Filed: Nov. 2, 2012
(86) PCT No.: PCT/JP2012/007039

§ 371 Date: Apr. 22, 2014

(30) Foreign Application Priority Data
Nov. 7, 2011 (JP) 2011-243366

(51) Int. Cl. F21V 7/04

(52) U.S. Cl. CPC F21V 7/04
USPC 362/235

(57) ABSTRACT

A lighting device (100) has a light-emitting element (120) positioned on a substrate (110), and a light beam control member (130) that reflects some of the light emitted by the light-emitting element (120), and allows some of the light to pass through. The light beam control member (130) has a reflective surface (132) that faces the light-emitting element (120), and reflects some of the light emitted by the light-emitting element (120). The reflective surface (132) has an aspherical curved surface, the height of which increases from the light-emitting element (120) toward the outer periphery from the center. The reflective surface (132) reflects light in a lateral direction in a region at the center, and reflects light in a backward direction in a region at the outer periphery.

### TECHNICAL FIELD

The present invention relates to an illumination apparatus that has a light emitting element and a light flux controlling member and that can be used in place of an incandescent lamp.

### BACKGROUND ART

In recent years, in view of energy saving and environmental protection, illumination apparatuses using a light-emitting diode (hereinafter referred to as “LED”) as a light source (for example, an LED lamp) are replacing incandescent lamps.

However, an illumination apparatus using a conventional LED as a light source emits light only in the forward direction and cannot emit light in a wide direction like an incandescent lamp. Therefore, the conventional illumination apparatuses cannot widely illuminate the interior of the room with light reflected from the ceiling and walls in the same way as incandescent lamps.

To bring the light distribution characteristics of the illumination apparatus using such a conventional LED as a light source close to those of the incandescent lamps, it is suggested to control the travelling direction of light emitted from the LED by the use of a light flux controlling member (for example, see PTL 1 and PTL 2).

FIG. 1 is a schematic diagram illustrating the configuration of an illumination apparatus described in PTL 1. As illustrated in FIG. 1, illumination apparatus 10 has multiple LEDs 12 disposed on a substrate and a cylindrical cover 14 formed of an optically transparent material around LED 12. The upper surface of cover 14 is formed in a reverse truncated cone shape. Aluminum plate 16 that reflects the light is attached to the slope of the truncated cone and functions as a reflection surface. Meanwhile, the plane of the truncated cone functions as transmissive window 18 through which the light is transmitted. As shown by the arrows in FIG. 1, part of the light emitted from LED 12 passes through transmissive window 18 and becomes emitted light toward the forward direction (upward). Moreover, part of the light emitted from LED 12 is reflected by aluminum plate 16 and becomes emitted light toward the lateral direction (horizontal direction).

FIG. 2 is a schematic diagram illustrating the configuration of an illumination apparatus described in PTL 2. As illustrated in FIG. 2, illumination apparatus 20 includes multiple LEDs 22 disposed on the apparatus body, diffusion cover 24 around LEDs 22, and transparent cover 26. Diffusion cover 24 has light diffusion characteristics and transmits and diffuses incident light. Moreover, a reflection surface is formed on the inner surface of diffusion cover 24 and diffusion cover 24 reflects part of the incident light to a transparent cover. Meanwhile, transparent cover 26 does not have the light diffusion characteristics and transmits the incident light as it is. As shown by the arrows in FIG. 2, part of the light emitted from LED 22 passes through diffusion cover 24 and becomes emitted light toward the forward direction (upward). Moreover, part of the light emitted from LED 22 is reflected by diffusion cover 24, is transmitted through transparent cover 26 and becomes emitted light toward the backward direction (downward).

With a light flux controlling member used in this way to control the travelling direction of the emitted light from an LED, it is possible to acquire the emitted light in not only the forward direction but also the lateral direction or the backward direction. Therefore, with the light flux controlling member (reflection surface) described in PTL 1 and PTL 2, it is possible to bring the light distribution characteristics of an illumination apparatus (LED lamp) close to those of incandescent lamps in some degree.

### CITATION LIST

### Patent Literature

PTL 1
Japanese Patent Application Laid-Open No. 2003-258319
PTL 2
Japanese Patent Application Laid-Open No. 2010-176890

### SUMMARY OF INVENTION

### Technical Problem

However, the illumination apparatuses described in PTL 1 and PTL 2 have the drawback of poor balance in the light distribution characteristics. Specifically, the illumination apparatus described in PTL 1 can achieve the light distribution in the forward direction and the lateral direction in some degree but cannot appropriately achieve the light distribution in the backward direction. Therefore, area A illustrated in FIG. 1 is darkened. Moreover, the illumination apparatus described in PTL 2 can achieve light distribution in the forward direction and the backward direction in some degree but cannot appropriately achieve the light distribution in the lateral direction. Therefore, area B illustrated in FIG. 2 is darkened. As described above, the illumination apparatuses described in PTL 1 and PTL 2 have poorer balance in the light distribution characteristics than incandescent lamps.

An object of the present invention is to provide an illumination apparatus that has a light emitting element and can distribute light even to the angular direction larger than the half-value angle, at which angle the amount of light is insufficient in the light distribution characteristics of a general light emitting element, and achieve the light distribution in all of the forward direction, the lateral direction and the backward direction in a balanced manner.

### Solution to Problem

The illumination apparatus of the present invention includes: one or more light emitting elements disposed on a substrate; and a light flux controlling member that is positioned relative to the light emitting element with air space in between such that an optical axis of the light emitting element and a central axis thereof coincide with each other, reflects part of light emitted from the light emitting element and transmits part of the light, wherein the light flux controlling member has a reflection surface that faces the light emitting element and reflects part of the light emitted from the light emitting element, the reflection surface has an aspherical curved surface whose height from the light emitting element increases toward an outer peripheral portion from a center portion, which center portion is an intersection with the optical axis of the light emitting element, the outer peripheral portion of the reflection surface is formed at a point distant from the light emitting element in a direction of the optical axis of the light emitting element, as compared with a position of the center portion of the reflection surface, and the reflection surface reflects part of the light emitted from the light emitting element so as to satisfy following Expression 1 when an angle of the light emitted along the optical axis of the light emitting element from the light emitting element is assumed to be 0°:

θ(a2)<θ(b2) (1)

where θ(a2) is an angle of light with respect to the optical axis of the light emitting element, where the light is emitted from a luminescence center of the light emitting element at an angle of θ(a1) with respect to the optical axis of the light emitting element and reflected by the reflection surface; θ(b2) is an angle of light with respect to the optical axis of the light emitting element, where the light is emitted from the luminescence center of the light emitting element at an angle of θ(b1) with respect to the optical axis of the light emitting element and reflected by the reflection surface; and θ(c1)≦θ(a1)<θ(b1) is established when an angle of a line with respect to the optical axis of the light emitting element is assumed to be θ(c1), where the line connects the luminescence center of the light emitting element with a point at which light arrives on the reflection surface, the light being emitted in a direction parallel to the optical axis of the light emitting element from a furthest point from the luminescence center of the light emitting element in the light emitting element.

The illumination apparatus of the present invention includes: one or more light emitting elements disposed on a substrate; and a light flux controlling member that is positioned relative to the light emitting element with air space in between such that an optical axis of the light emitting element and a central axis thereof coincide with each other, reflects part of light emitted from the light emitting element and transmits part of the light, wherein the light flux controlling member has a reflection surface that faces the light emitting element and reflects part of the light emitted from the light emitting element, the reflection surface has an aspherical curved surface whose height from the light emitting element increases toward an outer peripheral portion from a center portion, which center portion is an intersection with the optical axis of the light emitting element, the outer peripheral portion of the reflection surface is formed at a point distant from the light emitting element in a direction of the optical axis of the light emitting element, as compared with a position of the center portion of the reflection surface, and the reflection surface is a rotationally symmetric plane with respect to a central axis of the light flux controlling member and a generating line thereof has a concave shape with respect to the light emitting element.

### Advantageous Effects of Invention

An illumination apparatus of the present invention exhibits light distribution characteristics closer to those of incandescent lamps, as compared with the illumination apparatuses in the related art.

### BRIEF DESCRIPTION OF DRAWINGS

FIG. 1 is a schematic diagram illustrating the configuration of an illumination apparatus described in PTL 1;

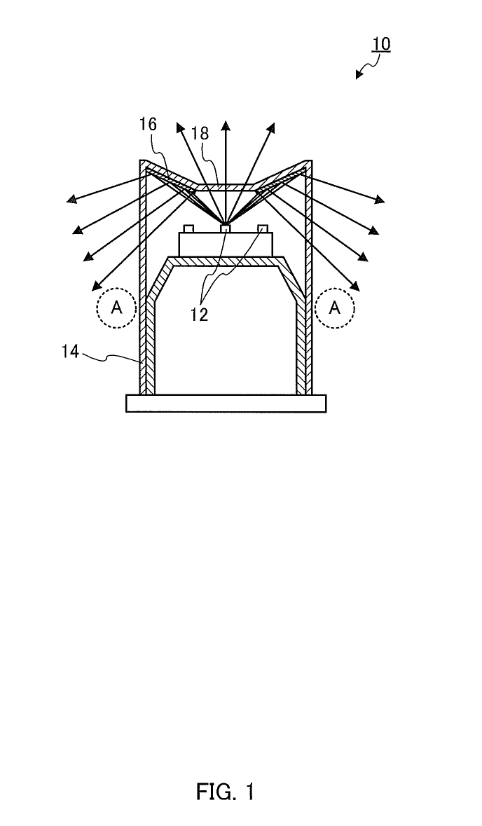

FIG. 2 is a schematic diagram illustrating the configuration of an illumination apparatus described in PTL 2;

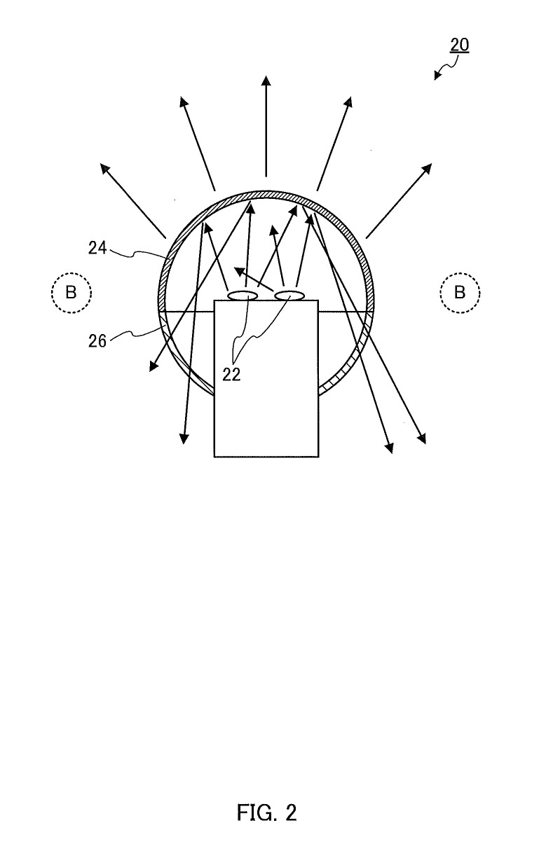

FIG. 3 is a cross-sectional view illustrating the configuration of an illumination apparatus according to Embodiment 1;

FIG. 4 is a cross-sectional view illustrating an example of optical paths in the illumination apparatus according to Embodiment 1;

FIG. 5 is a graph illustrating the relationship between angle (θ(r1)) of emitted light and angle (θ(r2)) of reflected light in the illumination apparatus according to Embodiment 1;

FIG. 6 is a graph illustrating the light distribution characteristics of the illumination apparatus according to Embodiment 1;

FIG. 7 is a cross-sectional view illustrating the configuration of an illumination apparatus according to Comparative Example 1;

FIG. 8 is a cross-sectional view illustrating an example of optical paths in the illumination apparatus according to Comparative Example 1;

FIG. 9 is a graph illustrating the relationship between angle (θ(r1)) of emitted light and angle (θ(r2)) of reflected light in the illumination apparatus according to Comparative Example 1;

FIG. 10 is a graph illustrating the light distribution characteristics of the illumination apparatus according to Comparative Example 1;

FIG. 11 is a cross-sectional view illustrating the configuration of an illumination apparatus according to Embodiment 2;

FIG. 12 is a cross-sectional view illustrating an example of optical paths in the illumination apparatus according to Embodiment 2;

FIG. 13 is a graph illustrating the relationship between angle (θ(r1)) of emitted light and angle (θ(r2)) of reflected light in the illumination apparatus according to Embodiment 2;

FIG. 14 is a graph illustrating the light distribution characteristics of the illumination apparatus according to Embodiment 2;

FIG. 15 is a cross-sectional view illustrating the configuration of the illumination apparatus according to Comparative Example 2;

FIG. 16 is a cross-sectional view illustrating an example of optical paths in the illumination apparatus according to Comparative Example 2;

FIG. 17 is a graph illustrating the relationship between angle (θ(r1)) of emitted light and angle (θ(r2)) of reflected light in the illumination apparatus according to Comparative Example 2;

FIG. 18 is a graph illustrating the light distribution characteristics of the illumination apparatus according to Comparative Example 2;

FIG. 19 is a cross-sectional view illustrating the configuration of an illumination apparatus according to Embodiment 3;

FIG. 20 is a cross-sectional view illustrating an example of optical paths in the illumination apparatus according to Embodiment 3;

FIG. 21 is a graph illustrating the relationship between angle (θ(r1)) of emitted light and angle (θ(r2)) of reflected light in the illumination apparatus according to Embodiment 3;

FIG. 22 is a graph illustrating the light distribution characteristics of the illumination apparatus according to Embodiment 3;

FIG. 23 is a cross-sectional view illustrating the configuration of the illumination apparatus according to Embodiment 4.

FIG. 24 is a cross-sectional view illustrating an example of optical paths in the illumination apparatus according to Embodiment 4;

FIG. 25 is a graph illustrating the relationship between angle (θ(r1)) of emitted light and angle (θ(r2)) of reflected light in the illumination apparatus according to Embodiment 4;

FIG. 26 is a graph illustrating the light distribution characteristics of the illumination apparatus according to Embodiment 4;

FIG. 27 is a cross-sectional view illustrating the configuration of an illumination apparatus according to Embodiment 5;

FIG. 28 is a cross-sectional view illustrating an example of optical paths in the illumination apparatus according to Embodiment 5;

FIG. 29 is a graph illustrating the relationship between angle (θ(r1)) of emitted light and angle (θ(r2)) of reflected light in the illumination apparatus according to Embodiment 5;

FIG. 30 is a graph illustrating the light distribution characteristics of the illumination apparatus according to Embodiment 5;

FIG. 31 is a cross-sectional view illustrating the configuration of an illumination apparatus according to Embodiment 6;

FIG. 32 is a cross-sectional view illustrating an example of optical paths in the illumination apparatus according to Embodiment 6;

FIG. 33 is a graph illustrating the relationship between angle (θ(r1)) of emitted light and angle (θ(r2)) of reflected light in the illumination apparatus according to Embodiment 6;

FIG. 34 is a graph illustrating the light distribution characteristics of the illumination apparatus according to Embodiment 6;

FIG. 35 is a cross-sectional view illustrating the configuration of a bulb-type illumination apparatus according to Embodiment 7;

FIG. 36 is a cross-sectional view illustrating an example of a bulb-type illumination apparatus including the illumination apparatus according to Embodiment 1;

FIG. 37 is a cross-sectional view illustrating another example of a bulb-type illumination apparatus including the illumination apparatus according to Embodiment 1;

FIG. 38 is a graph illustrating the light distribution characteristics of the illumination apparatus illustrated in FIG. 36;

FIG. 39 is a graph illustrating the light distribution characteristics of the illumination apparatus illustrated in FIG. 37;

FIG. 40 is a graph illustrating the light distribution characteristics of a bulb-type illumination apparatus according to Embodiment 7;

FIG. 41 is a cross-sectional view illustrating the configuration of a bulb-type illumination apparatus according to Embodiment 8;

FIG. 42 is a graph illustrating the light distribution characteristics of the bulb-type illumination apparatus according to Embodiment 8;

FIG. 43 is a cross-sectional view illustrating the configuration of a bulb-type illumination apparatus according to Embodiment 9;

FIG. 44 is a graph illustrating the light distribution characteristics of the bulb-type illumination apparatus according to Embodiment 9;

FIG. 45 is a cross-sectional view illustrating the configuration of a bulb-type illumination apparatus according to Embodiment 10;

FIG. 46 is a graph illustrating the light distribution characteristics of the bulb-type illumination apparatus according to Embodiment 10;

FIG. 47 is a cross-sectional view illustrating the configuration of a bulb-type illumination apparatus according to Embodiment 11; and

FIG. 48 is a graph illustrating the light distribution characteristics of the bulb-type illumination apparatus according to Embodiment 11.

### DESCRIPTION OF EMBODIMENTS

Embodiments of the present invention will be described in detail with reference to the accompanying drawings.

### Embodiment 1

### [Configuration of Illumination Apparatus]

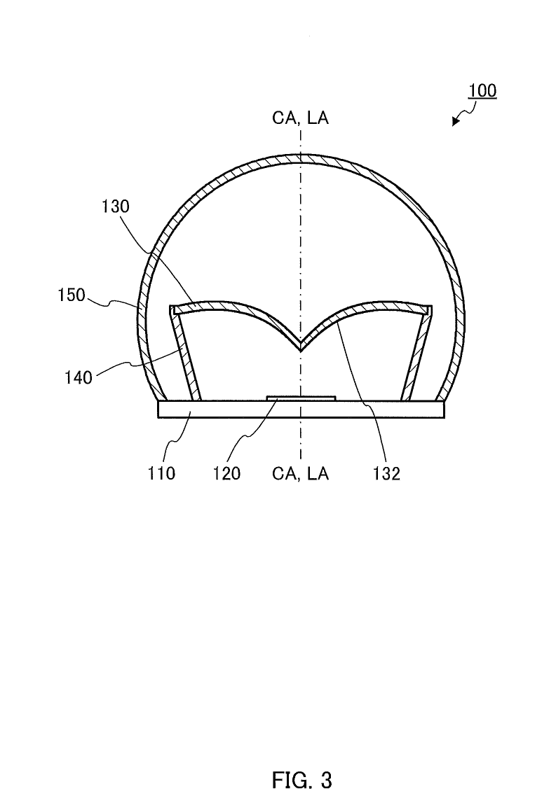

FIG. 3 is a cross-sectional view illustrating a configuration of illumination apparatus 100 according to Embodiment 1 of the present invention. Illumination apparatus 100 according to the present embodiment may be used in place of an incandescent lamp.

As illustrated in FIG. 3, illumination apparatus 100 has substrate 110, one or more light emitting elements 120, light flux controlling member 130, sidewall 140 and cover 150.

Light emitting element 120 is the light source of illumination apparatus 100 and is fixed onto substrate 110. Light emitting element 110 is, for example, a light-emitting diode (LED) such as a white light-emitting diode. In a case where multiple light emitting elements 120 are fixed onto substrate 110, each light emitting element 120 may be disposed on the circumference. To design the shape of reflection surface 132 (described later) of light flux controlling member 130, it is preferable that multiple light emitting elements 120 are disposed all over an area facing reflection surface 132. Here, the shape of substrate 110 is not particularly limited as long as it is possible to fix the light emitting elements, and it may not necessarily be formed in a plate shape.

Light flux controlling member 130 is a member of a substantially circular shape in plan view and controls the travelling direction of emitted light from light emitting element 120. Light flux controlling member 130 is supported by cylindrical sidewall portion 140 formed of an optically transparent material, and is positioned relative to light emitting element 120 with air space in between such that central axis CA coincides with optical axis LA of light emitting element 120. Specifically, light flux controlling member 130 is disposed so as to face light emitting element 120. In a case where multiple light emitting elements 120 are disposed on substrate 110, “the optical axis of the light emitting elements” denotes the travelling direction of light in the center of three-dimensional light fluxes from the multiple light emitting elements.

Light flux controlling member 130 reflects part of the light emitted from light emitting element 120 and transmits part of the light. Means of conferring such a function to light flux controlling member 130 is not particularly limited. For example, a transmissive/reflective coating may be formed on the surface of light flux controlling member 130 formed of an optically transparent material (surface facing light emitting element 120). Examples of the optically transparent material include transparent resin materials such as polymethylmethacrylate (PMMA), polycarbonate (PC) and epoxy resin (EP), and transparent glass. Examples of the transmissive/reflective coating include dielectric multilayers such as a multilayer film of TiO₂ and SiO₂, a multilayer film of ZnO₂ and SiO₂ and a multilayer film of Ta₂O₂ and SiO₂, and a metallic thin film formed of aluminum (Al). Moreover, light scattering elements such as a bead may be dispersed in light flux controlling member 130 formed of an optically transparent material. Specifically, light flux controlling member 130 may be formed of a material that reflects part of the light and transmits part of the light. Moreover, an optically transparent portion may be formed on light flux controlling member 130 formed of an optically reflective material. Examples of the optically reflective material include a white resin and metal, and so on. Examples of the optically transparent portion include a through-hole and a bottomed recess. In the latter case, emitted light from light emitting element 120 is transmitted through the bottom portion of the recess (thin portion).

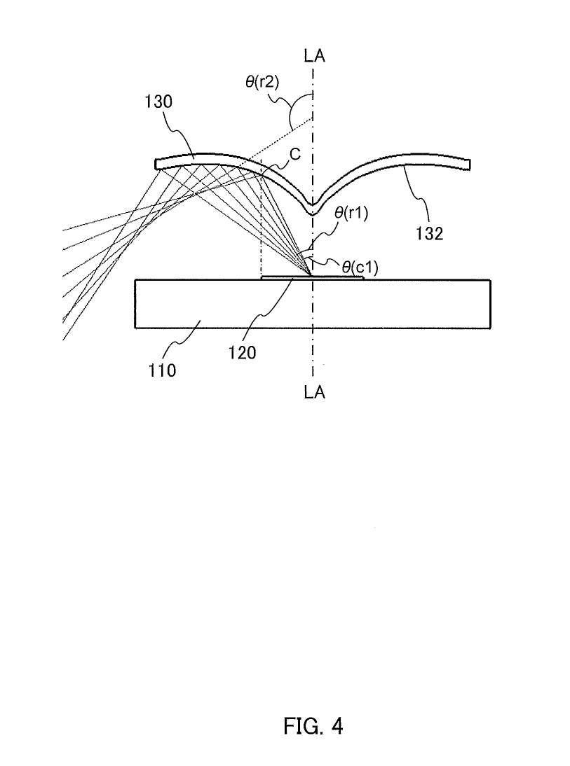

Light flux controlling member 130 has reflection surface 132 that faces light emitting element 120 and reflects part of the light emitted from light emitting element 120. In the following explanation, the angle of light with respect to optical axis LA of light emitting element 120 is assumed to be θ(r2), where the light is emitted from the luminescence center of light emitting element 120 at an angle of θ(r1) with respect to optical axis LA of light emitting element 120 and reflected by reflection surface 132 (see FIG. 4). Here, “θ(r1)” is the smaller angle of two angles formed by the emitted light from light emitting element 120 and optical axis LA. Moreover, “θ(r2)” is the larger angle of two angles formed by optical axis LA and the direction of the emitted light at angle θ(r1) reflected and directed by reflection surface 132. Moreover, when θ(r1) indicates a specific angle, θ(a1) and θ(b1), and so on, replace θ(r1). Similarly, when angle θ(r2) indicates a specific angle, θ(a2) and θ(b2), and so on, replace θ(r2). θ(a2) and θ(b2) are angles of light with respect to optical axis LA of light emitting element 120, where the light is emitted from the luminescence center of light emitting element 120 at an angle of θ(a1) or θ(b1) with respect to optical axis LA of light emitting element 120 and reflected by reflection surface 132.

Reflection surface 132 reflects the emitted light from light emitting element 120 to sidewall portion 140. From the other viewpoint, it can be said that reflection surface 132 reflects the emitted light from light emitting element 120 such that angle θ(r2) (see FIG. 4) of arbitrary reflected light with respect to optical axis LA of light emitting element 120 is larger than half-value angle θ(h1) of light emitting element 120. The reflected light is transmitted through sidewall portion 140 formed of an optically transparent material and arrives at cover 150.

Illumination apparatus 100 of the present invention is mainly characterized by the shape of reflection surface 132 of light flux controlling member 130. Therefore, the shape of reflection surface 132 of light flux controlling member 130 is separately described in detail.

Cover 150 is a material that has a hollow area formed therein with an opening. Light emitting element 120, light flux controlling member 130 and sidewall portion 140 are disposed in the hollow area of cover 150. Cover 150 transmits and diffuses the light whose travelling direction is controlled by light flux controlling member 130 (reflected light and transmitted light).

Means of conferring light diffusing ability to cover 150 is not particularly limited. For example, the inner surface or outer surface of cover 150 may be subjected to light diffusion treatment (for example, roughening) or cover 150 may be produced using a light diffuse material (for example, an optically transparent material containing a light-scattering element such as beads). The shape of cover 150 is not particularly limited as long as it is possible to attain desired light distribution characteristics. For example, the shape of cover 150 is a spherical crown shape (shape acquired by cutting out part of a sphere in a plane).

### [Shape of Reflection Surface of Light Flux Controlling Member]

Reflection surface 132 of light flux controlling member 130 is rotationally symmetric (circularly symmetric) plane about central axis CA of light flux controlling member 130. Moreover, as illustrated in FIG. 3, a generating line of this rotationally symmetric plane has a concave shape with respect to light emitting element 120. Specifically, reflection surface 132 has an aspherical curved surface whose height from light emitting element 120 increases toward the outer peripheral portion from the center portion. Moreover, as compared with the center portion of reflection surface 132, the outer peripheral portion of reflection surface 132 is formed at a point distant (in height) from light emitting element 120 in the direction of optical axis LA of light emitting element 120. For example, reflection surface 132 assumes an aspherical curved surface whose height from light emitting element 120 increases toward the outer peripheral portion from the center portion, or assumes an aspherical curved surface whose height from light emitting element 120 (substrate 110) increases toward the outer peripheral portion from the center portion between a predetermined point and the center portion, and the then height from light emitting element 120 decreases toward the outer peripheral portion from the center portion between the outer peripheral portion and the predetermined point. In the former case, the inclining angle of reflection surface 132 with respect to the plane direction of substrate 110 becomes small toward the outer peripheral portion from the center portion. On the other hand, in the latter case, reflection surface 132 has a point at which the inclining angle with respect to the plane direction of substrate 110 is zero (parallel to substrate 110) near the outer peripheral portion between the center portion and the outer peripheral portion.

To be more specific, reflection surface 132 is shaped to reflect part of the light emitted from light emitting element 120 to satisfy Expression 1 when the angle of the emitted light from light emitting element 120 to the forward direction of optical axis LA of light emitting element 120 is assumed to be 0°:

θ(a2)<θ(b2) (1)

FIG. 4 is a cross-sectional view illustrating an example of optical paths in illumination apparatus 100. In this figure, sidewall portion 140 and cover 150 are not illustrated. As described above, θ(a2) and θ(b2) (indicated as “θ(r2)” in FIG. 4) in above-mentioned Expression 1 are angles of light with respect to optical axis LA of light emitting element 120, where the light is emitted from the luminescence center of light emitting element 120 at an angle of θ(a1) or θ(b1) (indicated as “θ(r1)” in FIG. 4) with respect to optical axis LA of light emitting element 120 and reflected by reflection surface 132. Both θ(a1) and θ(b1) are arbitrary angles equal to or greater than θ(c1). However, it is assumed that θ(b1) is greater than θ(a1). Specifically, θ(c1)≦θ(a1)<θ(b1) is assumed in above-mentioned Expression 1.

θ(c1) is an angle that depends on the size and arrangement of light emitting element 120 and the interval between light emitting element 120 and light flux controlling member 130. Specifically, as illustrated in FIG. 4, in one or more in light emitting elements 120, the point at which the light emitted from the furthest point from the luminescence center toward the direction parallel to optical axis LA of light emitting element 120 arrives on reflection surface 132 is assumed to be C. The angle of the light, which is emitted from the luminescence center of light emitting element 120 to this point C, with respect to optical axis LA of light emitting element 120 is θ(c1).

Expression 1 above shows that, regarding light reflected in an area on an outer peripheral side from point C of reflection surface 132, the light reflected in a far outer peripheral area forms a larger angle with respect to optical axis LA of 120 light emitting element. Specifically, reflection surface 132 that satisfies above-mentioned Expression 1 reflects the light toward the lateral direction (horizontal direction) in an area on the center portion side and reflects the light toward the backward direction (lower direction) in an area on the outer peripheral portion side. In this way, light in the backward direction is generated in an area on the outer peripheral portion side instead of the center portion side of reflection surface 132, which makes it possible to efficiently illuminate the surface to be irradiated in the backward direction without being disturbed by substrate 110. If the light in the backward direction is generated in an area on the center portion side of reflection surface 132, it may be prevented by substrate 110 and therefore it may not be possible to efficiently illuminate the surface to be irradiated in the backward direction.

### [Evaluation Test]

### Illumination Apparatus According to Embodiment 1

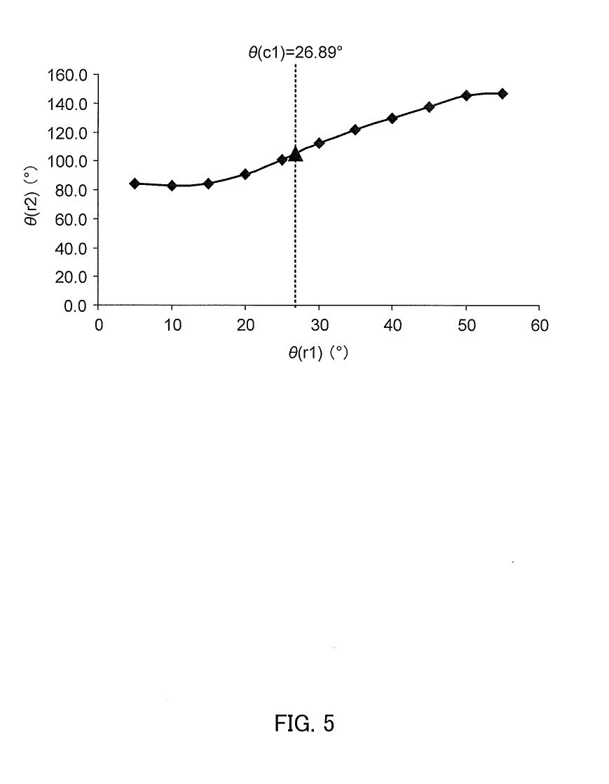

FIG. 5 is a graph (simulation) illustrating the relationship between angle (θ(r1)) of emitted light from the luminescence center of light emitting element 120 (size: 7.6 mm×6.6 mm) and angle (θ(r2)) of reflected light corresponding to the emitted light in illumination apparatus 100 according to Embodiment 1 illustrated in FIG. 3. The angles of the emitted light and the reflected light both are angles with respect to optical axis LA of light emitting element 120. In this illumination apparatus 100, θ(c1)=26.89°.

As shown in this graph, regarding the light of an emission angle equal to or greater than θ(c1) (26.89°), the reflection angle increases as the emission angle becomes larger. Accordingly, it is understood that, in illumination apparatus 100 according to Embodiment 1, light is reflected toward the lateral direction (horizontal direction) in an area on the center portion side of reflection surface 132 and the light is reflected toward the backward direction (lower direction) in an area on the outer peripheral portion side.

Next, the light distribution characteristics of illumination apparatus 100 according to Embodiment 1 were measured. The light distribution characteristics were measured according to the following procedures. An illuminometer was positioned at a point (the reference position: 0°) distant from the luminescence center of light emitting element 120 in illumination apparatus 100 by a predetermined distance along optical axis LA. The illuminometer was rotated by 180° at 5-degree intervals in the clockwise direction (+θ direction) with respect to the luminance center of light emitting element 120 and measured, and rotated by 180° at 5-degree intervals in the counterclockwise direction (−θ direction) with respect to the luminance center of light emitting element 120 and measured. The relative luminance values (dimensionless values) as determined with the highest luminance value among the measured luminance values set to 1 were smoothly connected into a curve to make a graph.

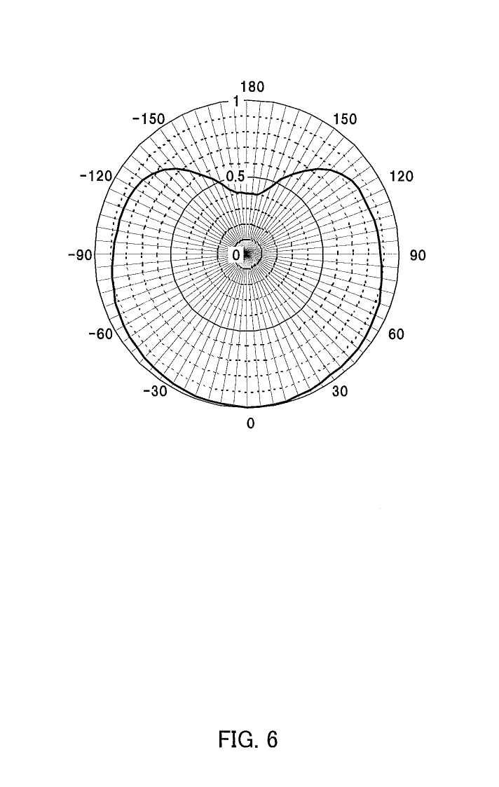

FIG. 6 is a graph illustrating the light distribution characteristics of illumination apparatus 100 according to Embodiment 1. In this graph, 0° represents the forward direction (upper direction), 90° represents the lateral direction (horizontal direction) and 180° represents the backward direction (lower direction). It is understood from FIG. 6 that illumination apparatus 100 according to Embodiment 1 has wide and balanced light distribution characteristics.

### Illumination Apparatus According to Comparative Example 1

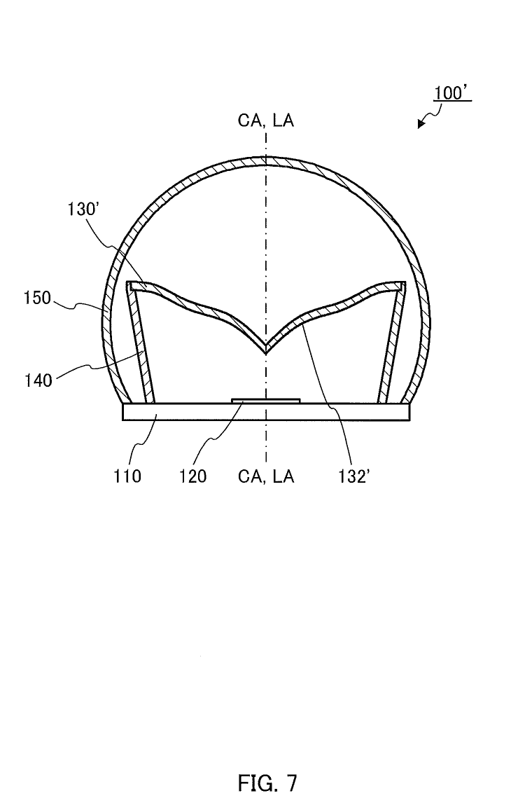

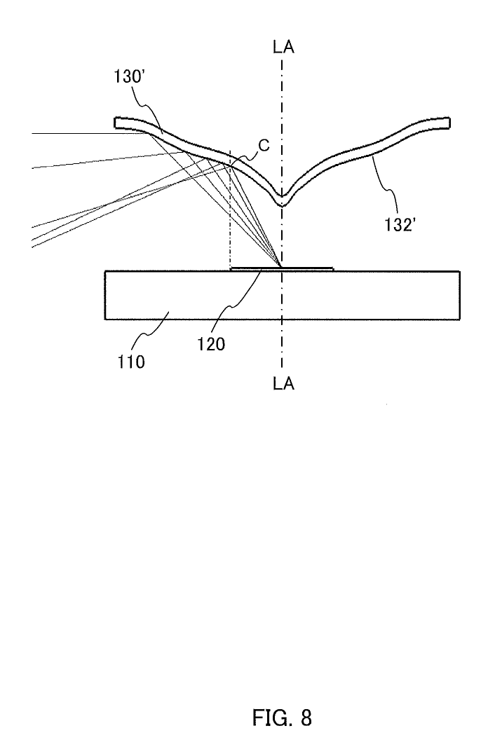

FIG. 7 is a cross-sectional view illustrating the configuration of illumination apparatus 100′ according to Comparative Example 1 and FIG. 8 is a cross-sectional view illustrating an example of an optical path in illumination apparatus 100′ according to Comparative Example 1. As illustrated in FIG. 7 and FIG. 8, illumination apparatus 100′ according to Comparative Example 1 is different from illumination apparatus 100 according to Embodiment 1 in the shape of reflection surface 132′ of light flux controlling member 130′.

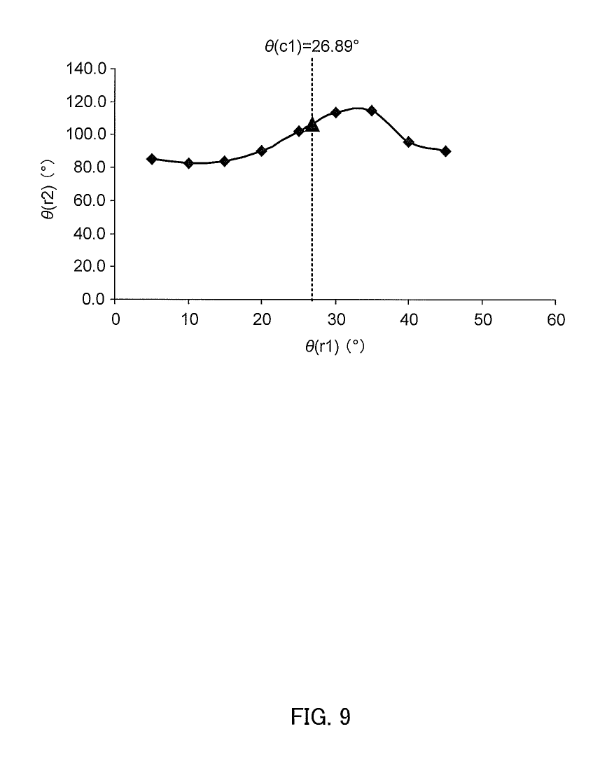

FIG. 9 is a graph illustrating the relationship between angle (θ(r1)) of emitted light from the luminescence center of light emitting element 120 (size: 7.6 mm×6.6 mm) and angle (θ(r2)) of reflected light corresponding to the emitted light in illumination apparatus 100′ according to Comparative Example 1 illustrated in FIG. 7. In this illumination apparatus 100′, θ(c1)=26.89°. As shown in this graph, in illumination apparatus 100′ according to Comparative Example 1, the reflection angle becomes small when the emission angle exceeds 35°. It is understood from this that illumination apparatus 100′ according to Comparative Example 1 cannot reflect light toward the backward direction (lower direction) in an area on the outer peripheral portion side of reflection surface 132′ (see FIG. 8).

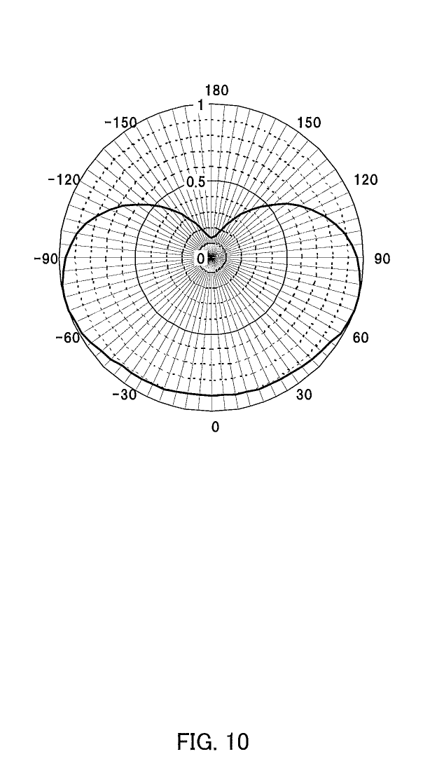

FIG. 10 is a graph illustrating the light distribution characteristics of illumination apparatus 100′ according to Comparative Example 1. It is understood from this graph that illumination apparatus 100′ according to Comparative Example 1 cannot achieve the light distribution sufficiently in the backward direction.

### [Effect]

Illumination apparatus 100 according to Embodiment 1 reflects part of light emitted from light emitting element 120 and arriving at light flux controlling member 130 to the lateral direction and backward direction by reflection surface 132 and transmits part of the light in the forward direction. At this time, by adjusting the light reflectance and transmittivity of light flux controlling member 130, it is possible to easily control the amount of emitted light in each direction. Moreover, illumination apparatus 100 according to Embodiment 1 generates reflected light in the lateral direction in an area on the center portion side of reflection surface 132 and generates reflected light in the backward direction in an area on the outer peripheral portion side. Therefore, illumination apparatus 100 according to Embodiment 1 can efficiently illuminate the surface to be irradiated in the backward direction without being disturbed by substrate 110.

As described above, illumination apparatus 100 according to Embodiment 1 can control the amounts of emitted light toward the forward direction, the lateral direction and the backward direction, and realize the light distribution characteristics close to an incandescent lamp. Illumination apparatus 100 according to Embodiment 1 can be used for interior illumination or the like in place of the incandescent lamp. Moreover, illumination apparatus 100 according to Embodiment 1 can save the power consumption as compared with the incandescent lamp and be used for a longer period than the incandescent lamp.

### Embodiment 2

### [Configuration of Illumination Apparatus]

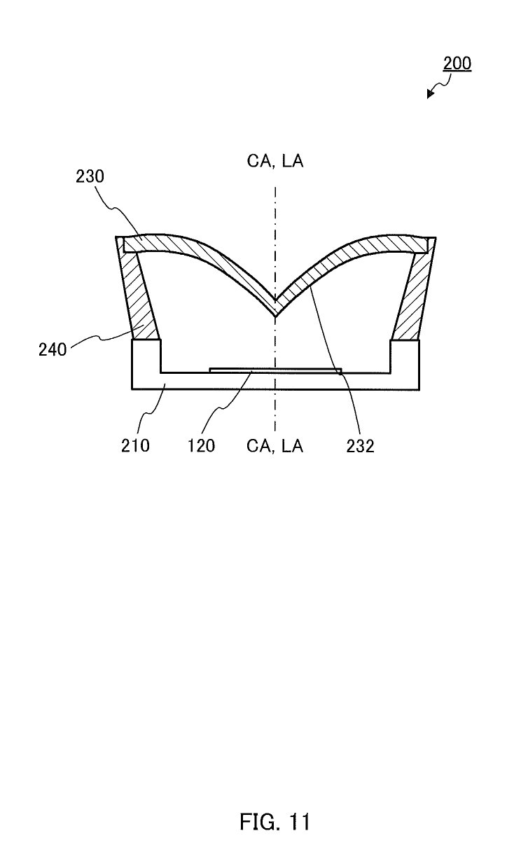

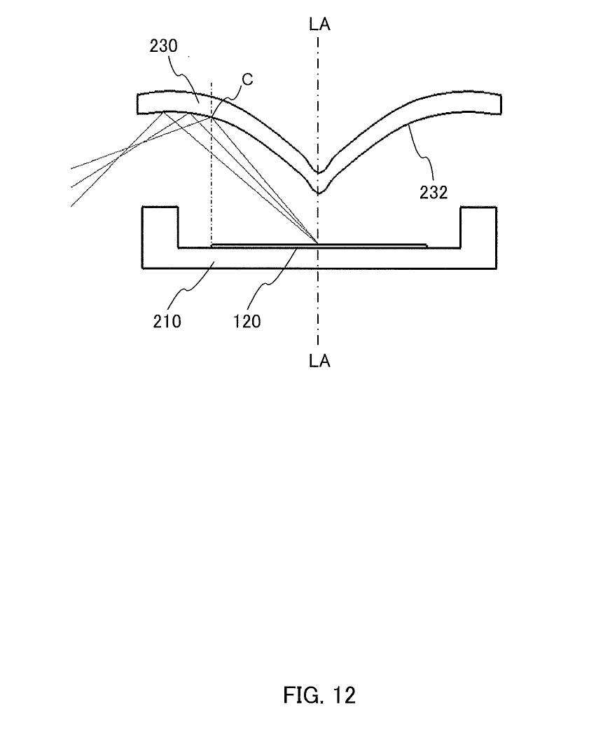

FIG. 11 is a cross-sectional view illustrating the configuration of illumination apparatus 200 according to Embodiment 2 of the present invention and FIG. 12 is a cross-sectional view illustrating an example of an optical path in illumination apparatus 200 according to Embodiment 2. In illumination apparatus 200 according to Embodiment 2, the shapes of substrate 210, light flux controlling member 230 and sidewall portion 240 are slightly different from illumination apparatus 100 according to Embodiment 1. Moreover, illumination apparatus 200 according to Embodiment 2 is also different from illumination apparatus 100 according to Embodiment 1 in that the cover is not provided.

### [Evaluation Test]

### Illumination Apparatus According to Embodiment 2

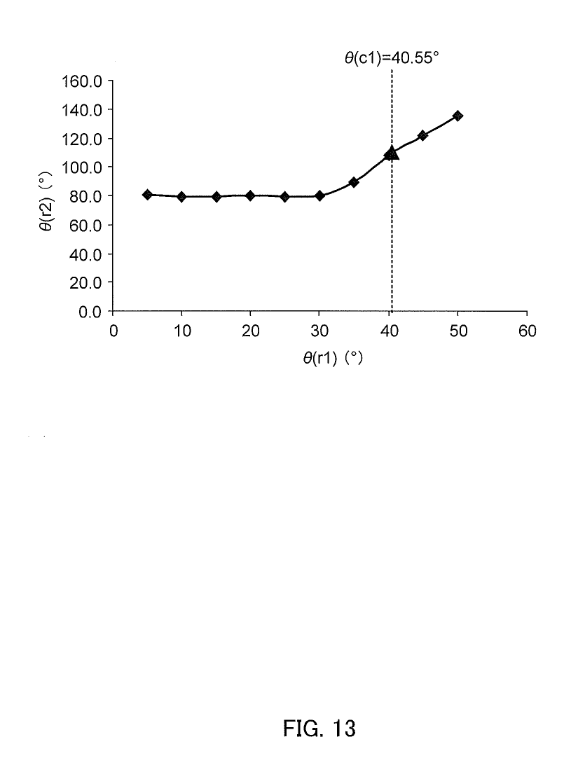

FIG. 13 is a graph illustrating the relationship between angle (θ(r1)) of emitted light from the luminescence center of light emitting element 120 (size: 16 mm×14 mm) and angle (θ(r2)) of reflected light corresponding to the emitted light in illumination apparatus 200 according to Embodiment 2. In this illumination apparatus 200, θ(c1)=40.55°.

As shown in this graph, regarding light at an emission angle equal to or greater than θ(c1) (40.55°), the reflection angle increases as the emission angle becomes larger. Accordingly, it is understood that, in illumination apparatus 200 according to Embodiment 2, light is reflected toward the lateral direction in an area on the center portion side of reflection surface 232 and the light is reflected toward the backward direction in an area on the outer peripheral portion side.

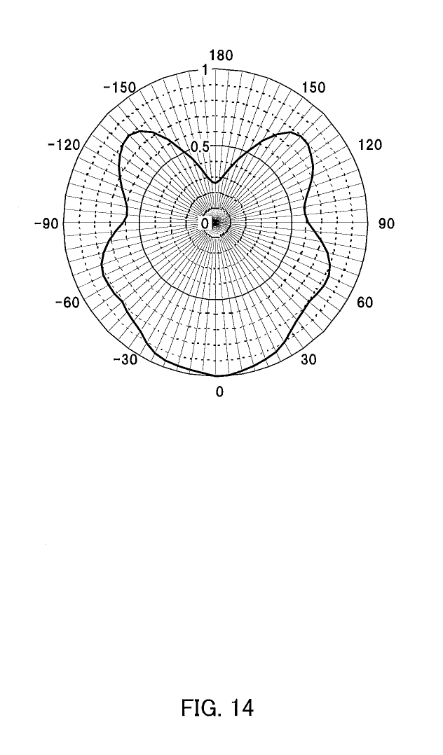

FIG. 14 is a graph illustrating the light distribution characteristics of illumination apparatus 200 according to Embodiment 2. It is understood from this graph that illumination apparatus 200 according to Embodiment 2 has wide and balanced light distribution characteristics.

### Illumination Apparatus According to Comparative Example 2

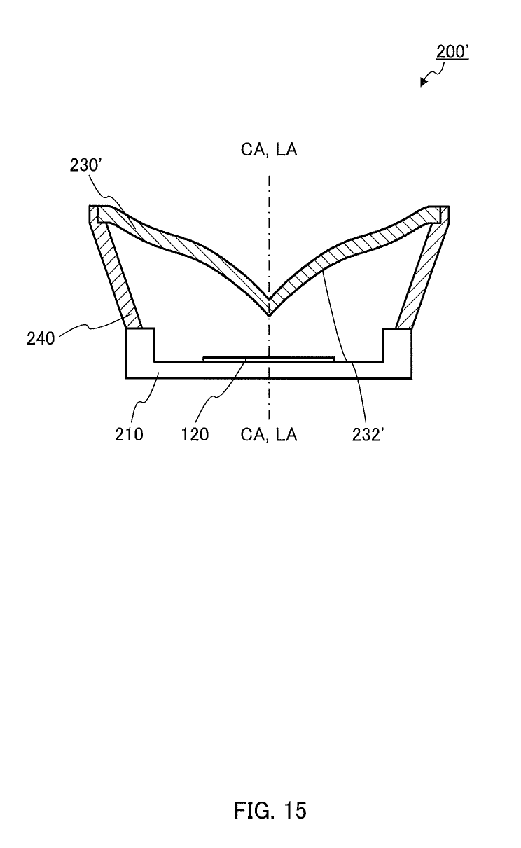

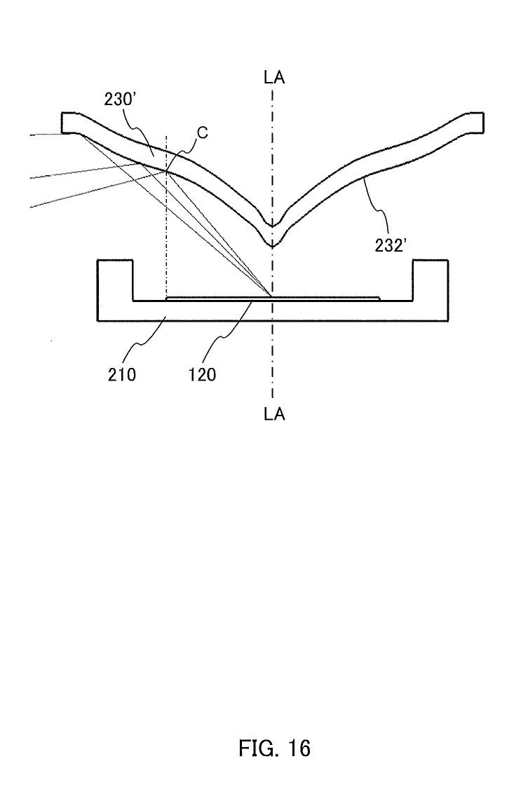

FIG. 15 is a cross-sectional view illustrating the configuration of illumination apparatus 200′ according to Comparative Example 2 and FIG. 16 is a cross-sectional view illustrating an example of an optical path in illumination apparatus 200′ according to Comparative Example 2. As illustrated in FIG. 15 and FIG. 16, illumination apparatus 200′ according to Comparative Example 2 is different from illumination apparatus 200 according to Embodiment 2 in the shape of reflection surface 232′ of light flux controlling member 230′.

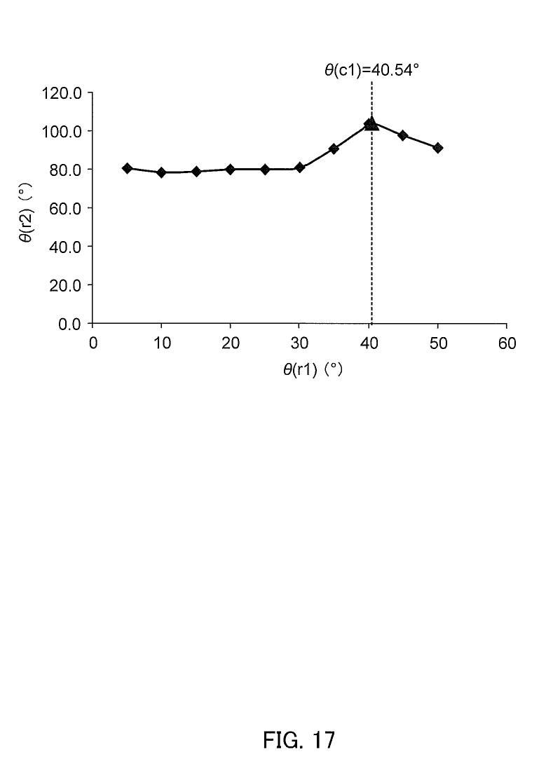

FIG. 17 is a graph illustrating the relationship between angle (θ(r1)) of emitted light from the luminescence center of light emitting element 120 (size: 16 mm×14 mm) and angle (θ(r2)) of reflected light corresponding to the emitted light in illumination apparatus 200′ according to Embodiment 2. In this illumination apparatus 200′, θ(c1)=40.54°. As shown in this graph, in illumination apparatus 200′ according to Comparative Example 2, when the emission angle exceeds 40°, the reflection angle becomes small. It is understood from this that illumination apparatus 200′ according to Comparative Example 2 cannot reflect light toward the backward direction (lower direction) in an area on the outer peripheral portion side of reflection surface 232′ (see FIG. 16).

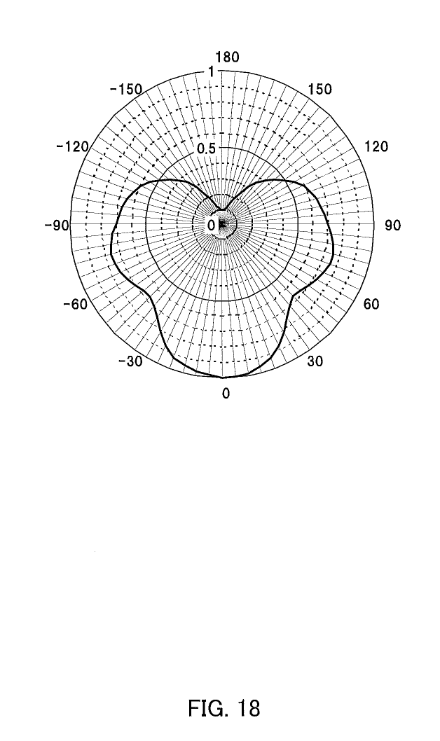

FIG. 18 is a graph illustrating the light distribution characteristics of illumination apparatus 200′ according to Comparative Example 2. It is understood from FIG. 18 that illumination apparatus 200′ according to Comparative Example 2 cannot achieve the light distribution sufficiently in the backward direction.

### [Effect]

Illumination apparatus 200 according to Embodiment 2 has a similar effect to illumination apparatus 100 according to Embodiment 1. Illumination apparatus 200 according to Embodiment 2 can be used for interior illumination or the like in place of an incandescent lamp.

### Embodiment 3

### [Configuration of Illumination Apparatus]

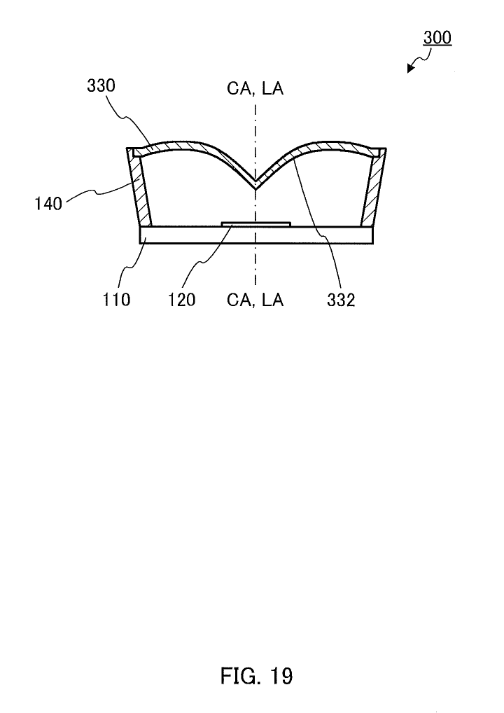

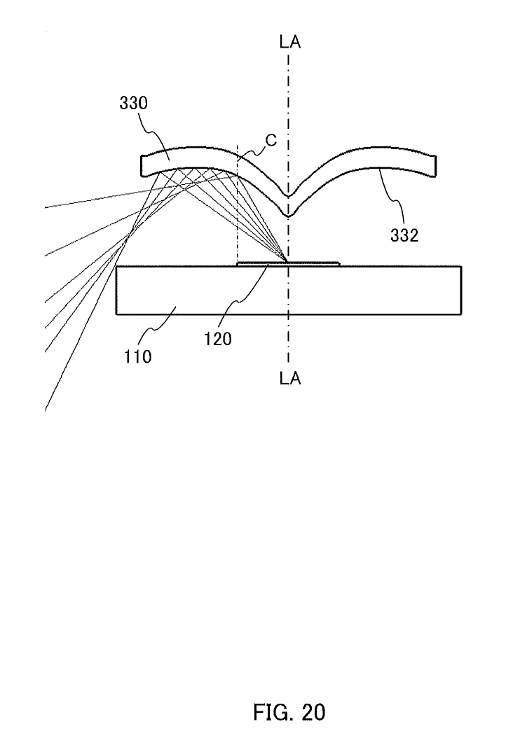

FIG. 19 is a cross-sectional view illustrating the configuration of illumination apparatus 300 according to Embodiment 3 of the present invention and FIG. 20 is a cross-sectional view illustrating an example of an optical path in illumination apparatus 300 according to Embodiment 3. In illumination apparatus 300 according to Embodiment 3, the shape of light flux controlling member 330 is slightly different from illumination apparatus 100 according to Embodiment 1. Moreover, illumination apparatus 300 according to Embodiment 3 is also different from illumination apparatus 100 according to Embodiment 1 in that a cover is not provided.

### [Evaluation Test]

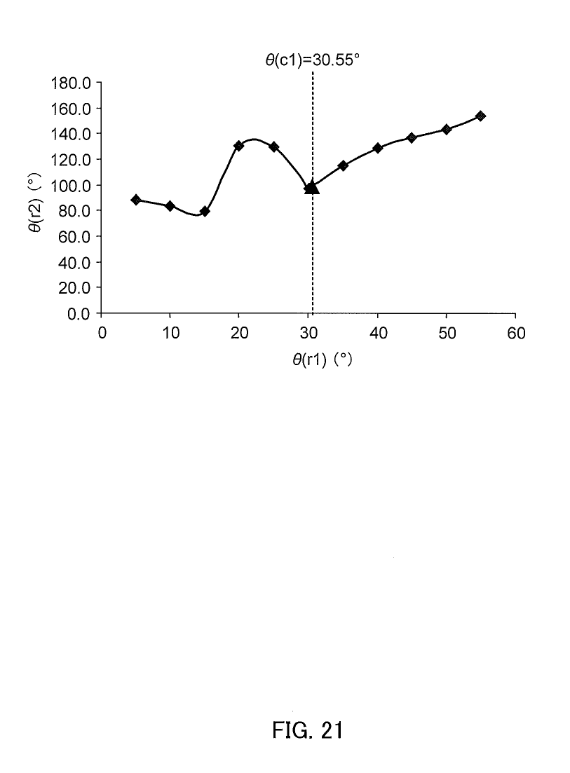

FIG. 21 is a graph illustrating the relationship between angle (θ(r1)) of emitted light from the luminescence center of light emitting element 120 (size: 7.6 mm×6.6 mm) and angle (θ(r2)) of reflected light corresponding to the emitted light in illumination apparatus 300 according to Embodiment 3. In this illumination apparatus 300, θ(c1)=30.55°.

As shown in this graph, regarding light at an emission angle equal to or greater than θ(c1) (30.55°), the reflection angle increases as the emission angle becomes larger. Accordingly, it is understood that, in illumination apparatus 300 according to Embodiment 3, light is reflected toward the lateral direction in an area on the center portion side of reflection surface 332 and the light is reflected toward the backward direction in an area on the outer peripheral portion side.

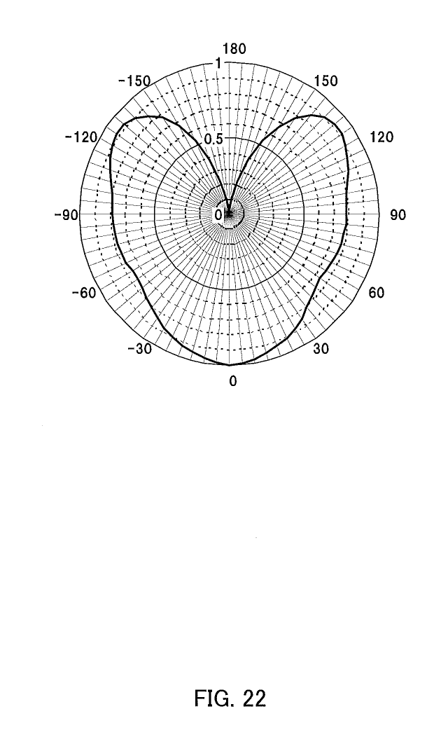

FIG. 22 is a graph illustrating the light distribution characteristics of illumination apparatus 300 according to Embodiment 3. It is understood from this graph that illumination apparatus 300 according to Embodiment 3 has wide and balanced light distribution characteristics.

### [Effect]

Illumination apparatus 300 according to Embodiment 3 has a similar effect to illumination apparatus 100 according to Embodiment 1. Illumination apparatus 300 according to Embodiment 3 can be used for interior illumination or the like in place of an incandescent lamp.

### Embodiment 4

### [Configuration of Illumination Apparatus]

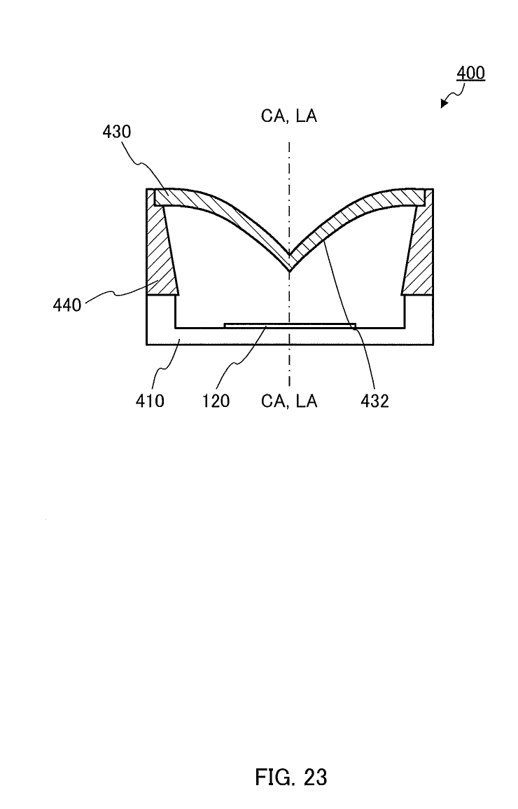

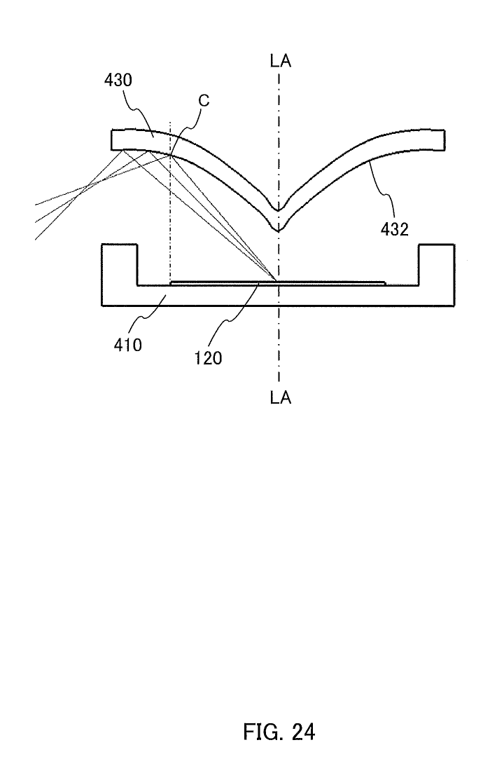

FIG. 23 is a cross-sectional view illustrating the configuration of illumination apparatus 400 according to Embodiment 4 of the present invention and FIG. 24 is a cross-sectional view illustrating an example of an optical path in illumination apparatus 400 according to Embodiment 4. In illumination apparatus 400 according to Embodiment 4, the shapes of substrate 410, light flux controlling member 430 and sidewall portion 440 are slightly different from illumination apparatus 100 according to Embodiment 1. Moreover, illumination apparatus 400 according to Embodiment 4 is also different from illumination apparatus 100 according to Embodiment 1 in that a cover is not provided.

### [Evaluation Test]

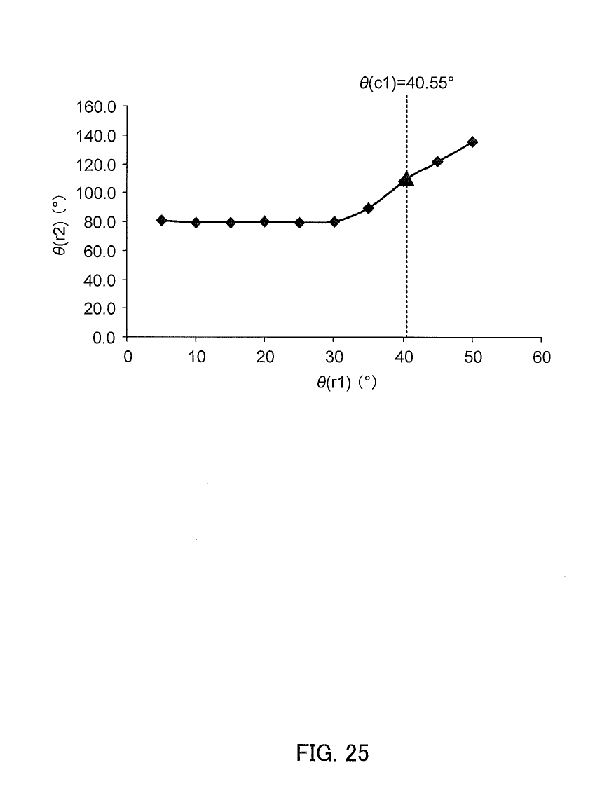

FIG. 25 is a graph illustrating the relationship between angle (θ(r1)) of emitted light from the luminescence center of light emitting element 120 (size: 16 mm×14 mm) and angle (θ(r2)) of reflected light corresponding to the emitted light in illumination apparatus 400 according to Embodiment 4. In this illumination apparatus 400, θ(c1)=40.55°.

As shown in this graph, regarding light at an emission angle equal to or greater than θ(c1) (40.55°), the reflection angle increases as the emission angle becomes larger. Accordingly, it is understood that, in illumination apparatus 400 according to Embodiment 4, light is reflected toward the lateral direction in an area on the center portion side of reflection surface 432 and the light is reflected toward the backward direction in an area on the outer peripheral portion side (see FIG. 24).

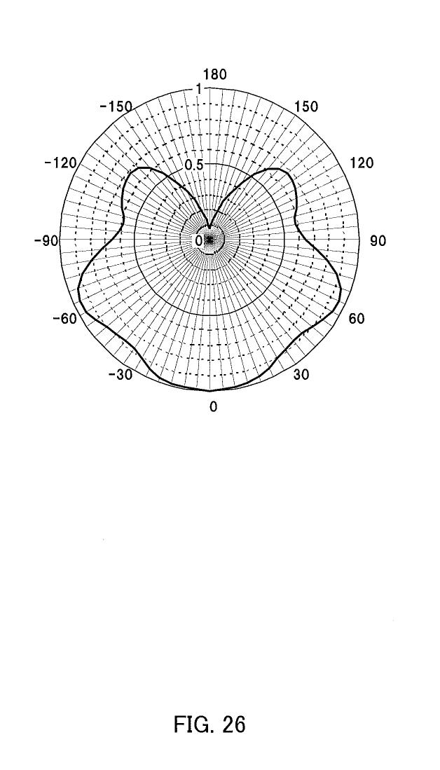

FIG. 26 is a graph illustrating the light distribution characteristics of illumination apparatus 400 according to Embodiment 4. It is understood from this graph that illumination apparatus 400 according to Embodiment 4 has wide and balanced light distribution characteristics.

### [Effect]

Illumination apparatus 400 according to Embodiment 4 has a similar effect to illumination apparatus 100 according to Embodiment 1. Illumination apparatus 400 according to Embodiment 4 can be used for interior illumination or the like in place of an incandescent lamp.

### Embodiment 5

### [Configuration of Illumination Apparatus]

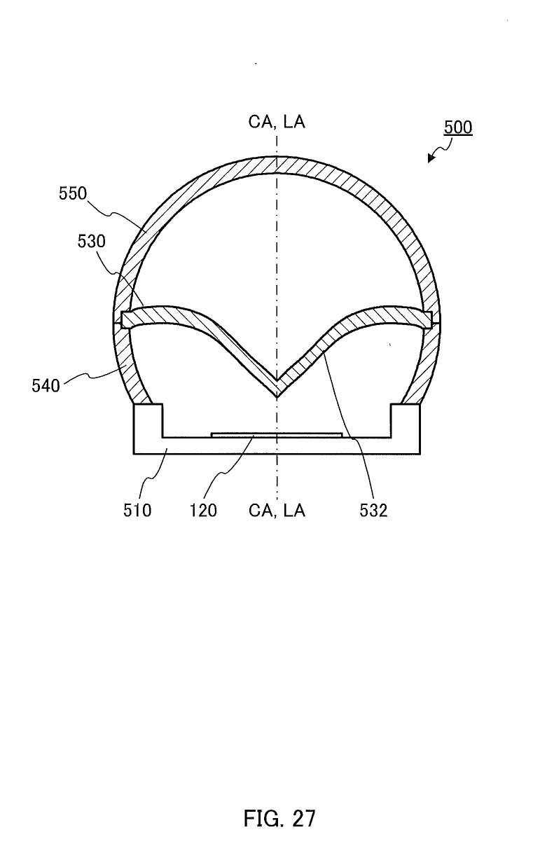

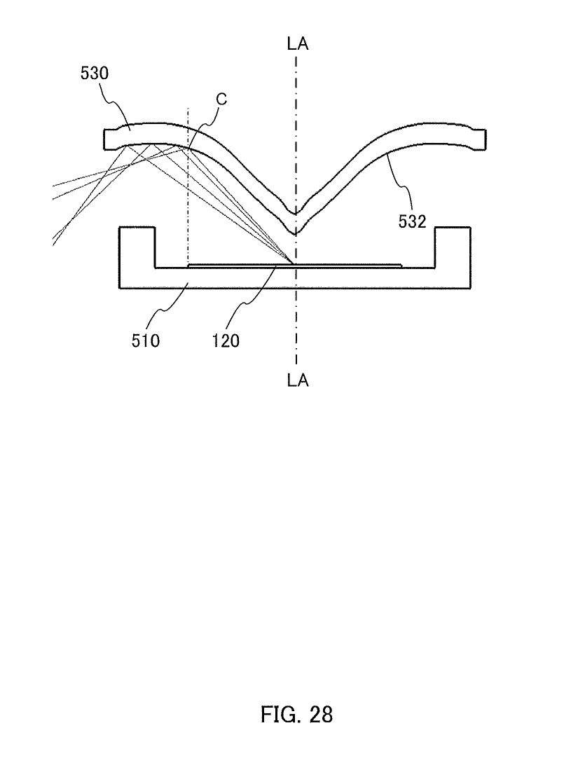

FIG. 27 is a cross-sectional view illustrating the configuration of illumination apparatus 500 according to Embodiment 5 of the present invention and FIG. 28 is a cross-sectional view illustrating an example of an optical path in illumination apparatus 500 according to Embodiment 5.

As illustrated in FIG. 27, illumination apparatus 500 has substrate 510, one or more light emitting elements 120, light flux controlling member 530, sidewall portion 540 and lid portion 550. In illumination apparatus 500 according to Embodiment 5, the shape of light flux controlling member 530 is slightly different from illumination apparatus 100 according to Embodiment 1. Moreover, illumination apparatus 500 according to Embodiment 5 is different from illumination apparatus 100 according to Embodiment 1 in that sidewall portion 540 and lid portion 550 are combined to function as a cover.

Sidewall portion 540 supports light flux controlling member 530 and diffuses light reflected by light flux controlling member 530. Moreover, lid portion 550 covers light flux controlling member 530 with air space in between and diffuses light transmitted through light flux controlling member 530. Specifically, sidewall portion 540 and lid portion 550 function as a cover that diffuses light whose travelling direction is controlled by light flux controlling member 530.

### [Evaluation Test]

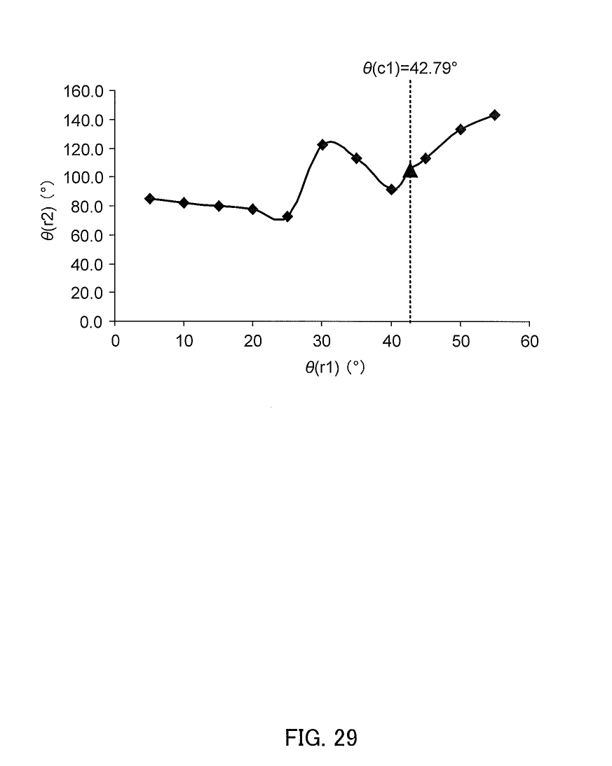

FIG. 29 is a graph illustrating the relationship between angle (θ(r1)) of emitted light from the luminescence center of light emitting element 120 (size: 16 mm×14 mm) and angle (θ(r2)) of reflected light corresponding to the emitted light in illumination apparatus 500 according to Embodiment 5. In this illumination apparatus 400, θ(c1)=42.79°.

As shown in this graph, regarding light at an emission angle equal to or greater than θ(c1) (42.79°), the reflection angle increases as the emission angle becomes larger. Accordingly, it is understood that, in illumination apparatus 500 according to Embodiment 5, light is reflected toward the lateral direction in an area on the center portion side of reflection surface 532 and the light is reflected toward the backward direction in an area on the outer peripheral portion side (see FIG. 28).

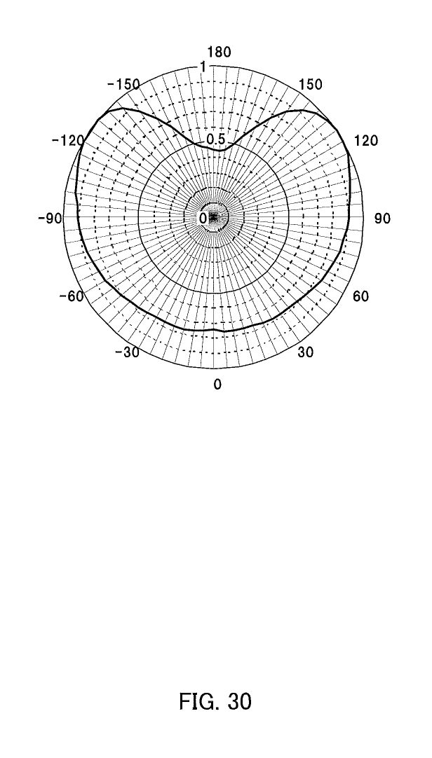

FIG. 30 is a graph illustrating the light distribution characteristics of illumination apparatus 500 according to Embodiment 5. It is understood from this graph that illumination apparatus 500 according to Embodiment 5 has wide and balanced light distribution characteristics.

### [Effect]

Illumination apparatus 500 according to Embodiment 5 has a similar effect to illumination apparatus 100 according to Embodiment 1. Illumination apparatus 500 according to Embodiment 5 can be used for interior illumination or the like in place of an incandescent lamp.

### Embodiment 6

### [Configuration of Illumination Apparatus]

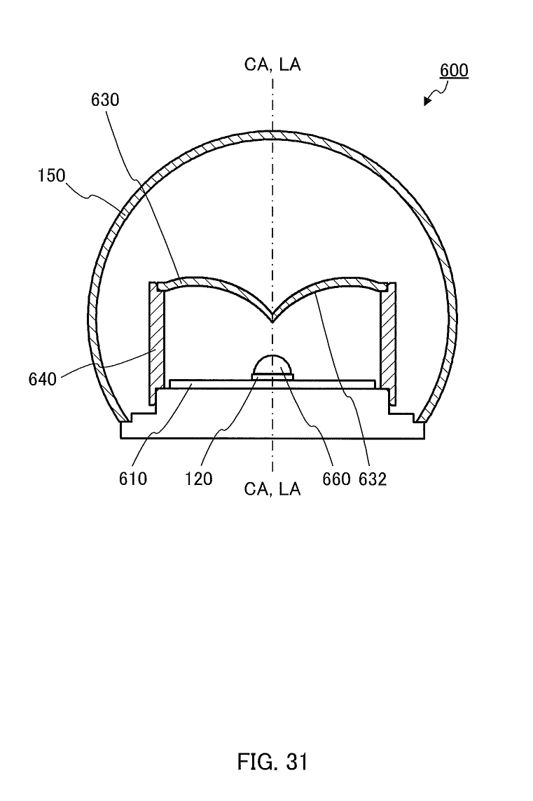

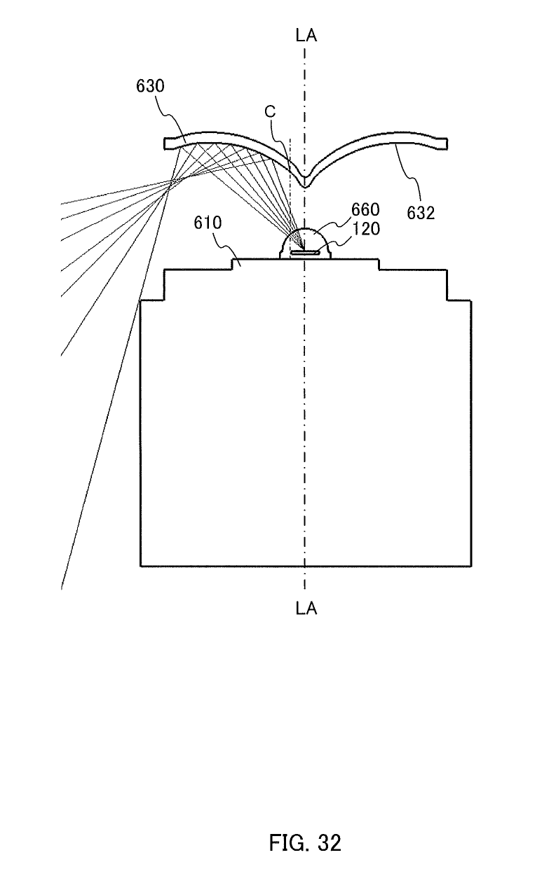

FIG. 31 is a cross-sectional view illustrating the configuration of illumination apparatus 600 according to Embodiment 6 of the present invention and FIG. 32 is a cross-sectional view illustrating an example of an optical path in illumination apparatus 600 according to Embodiment 6. In illumination apparatus 600 according to Embodiment 6, the shapes of substrate 610, light flux controlling member 630 and sidewall portion 640 are slightly different from illumination apparatus 100 according to Embodiment 1. Moreover, illumination apparatus 600 according to Embodiment 6 is also different from illumination apparatus 100 according to Embodiment 1 in that lens 660 that covers light emitting element 120 is provided.

### [Evaluation Test]

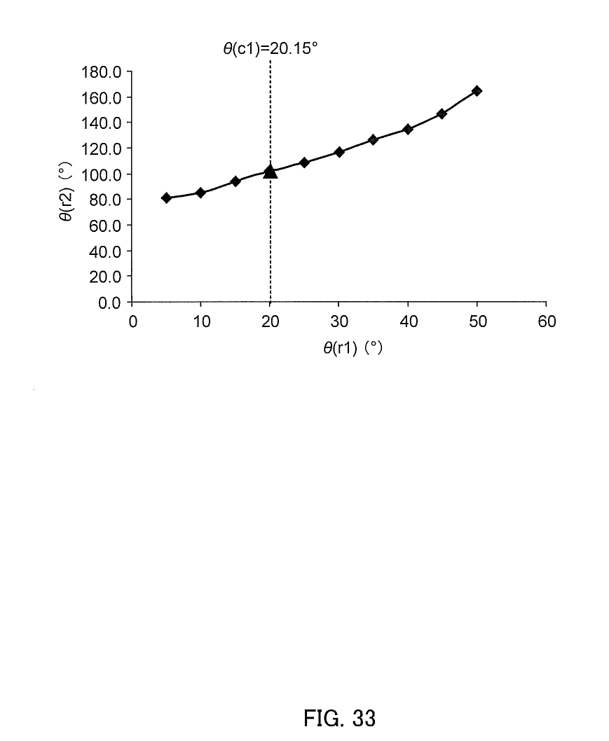

FIG. 33 is a graph illustrating the relationship between angle (θ(r1)) of emitted light from the luminescence center of light emitting element 120 (size: 1 mm×1 mm) and angle (θ(r2)) of reflected light corresponding to the emitted light in illumination apparatus 600 according to Embodiment 6. In this illumination apparatus 600, θ(c1)=20.15°.

As shown in this graph, regarding light at an emission angle equal to or greater than θ(c1) (20.15°), the reflection angle increases as the emission angle becomes larger. Accordingly, it is understood that, in illumination apparatus 600 according to Embodiment 6, light is reflected toward the lateral direction in an area on the center portion side of reflection surface 632 and the light is reflected toward the backward direction in an area on the outer peripheral portion side (see FIG. 32).

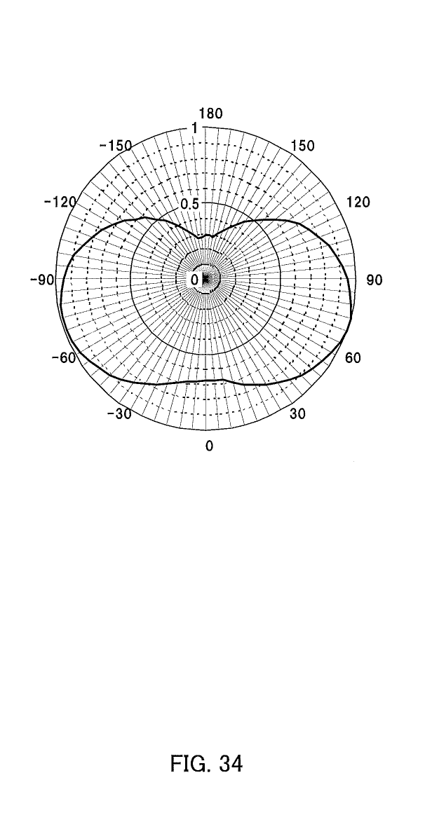

FIG. 34 is a graph illustrating the light distribution characteristics of illumination apparatus 600 according to Embodiment 6. It is understood from this graph that illumination apparatus 600 according to Embodiment 6 has wide and balanced light distribution characteristics.

### [Effect]

Illumination apparatus 600 according to Embodiment 6 has a similar effect to illumination apparatus 100 according to Embodiment 1. Illumination apparatus 600 according to Embodiment 6 can be used for interior illumination or the like in place of an incandescent lamp.

### Embodiment 7

### [Configuration of Illumination Apparatus]

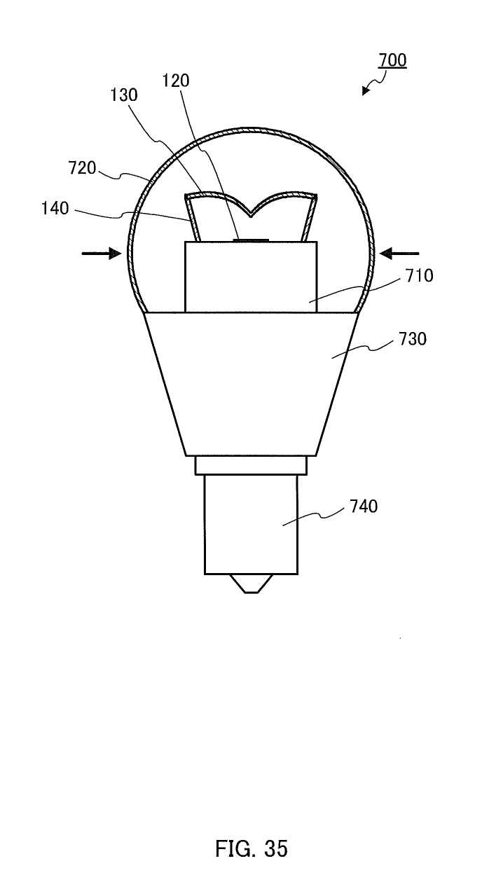

FIG. 35 is a cross-sectional view illustrating the configuration of illumination apparatus 700 according to Embodiment 7 of the present invention. As illustrated in FIG. 35, illumination apparatus 700 has one or more light emitting elements 120, light flux controlling member 130, sidewall portion 140, base 710, cover 720, lamp casing 730 and cap 740. Illumination apparatus 700 according to Embodiment 7 has a bulb-type shape and is used in the same way as an incandescent lamp.

Light emitting element 120, light flux controlling member 130 and sidewall portion 140 are the same as those included in illumination apparatus 100 according to Embodiment 1. Light emitting element 120, light flux controlling member 130 and sidewall portion 140 are disposed on base 710. Moreover, light emitting element 120, light flux controlling member 130 and sidewall portion 140 are disposed in the hollow area of cover 720 such that light emitting element 120 is located closer to the opening side of cover 720 than light flux controlling member 130 and optical axis LA of light emitting element 120 and the central axis of cover 720 coincide with each other.

Base 710 is provided on lamp casing 730 to adjust the positional relationship of cover 720 with respect to light emitting element 120, light flux controlling member 130 sidewall portion 140. In base 710, a circuit that connects light emitting element 120 with a circuit in lamp casing 730 is provided.

Cover 720 is a member that has a hollow area formed therein with an opening. As described above, light emitting element 120, light flux controlling member 130 and sidewall portion 140 are disposed in the hollow area of cover 720. Cover 720 transmits and diffuses reflected light and transmitted light from light flux controlling member 130. In the example illustrated in FIG. 35, the shape of cover 720 is a substantially spherical crown shape. Cover 720 is fixed to the upper part of lamp casing 730 and the opening of cover 720 is closed with lamp casing 730.

In lamp casing 730, an electric circuit that allows light emitting element 120 to emit light is provided. This electric circuit is connected with cap 740 and light emitting element 120. Moreover, lamp casing 730 functions as a radiator.

Illumination apparatus 700 according to the present embodiment is characterized by light emitting element 120, light flux controlling member 130 and sidewall portion 140 that are disposed in a predetermined position in cover 720. Specifically, in illumination apparatus 700 according to the present embodiment, light emitting element 120, light flux controlling member 130 and sidewall portion 140 are located above (the opposite side to the opening) the maximum outer diameter part of cover 720 (shown by the arrows in FIG. 35). Moreover, in illumination apparatus 700 according to the present embodiment, the opening of cover 720 is located on the lower side (the negative direction when the emission direction of light along the optical axis of light emitting element 120 is assumed to be positive) as compared with light emitting element 120.

Thus, by disposing light emitting element 120, light flux controlling member 130 and sidewall portion 140 above the opening of cover 720, light reflected by light flux controlling member 130 in the backward direction is less likely to be disturbed by lamp casing 730. Therefore, it is possible to bring the light distribution characteristics of illumination apparatus 700 close to those of an incandescent lamp regardless of the size of lamp casing 730.

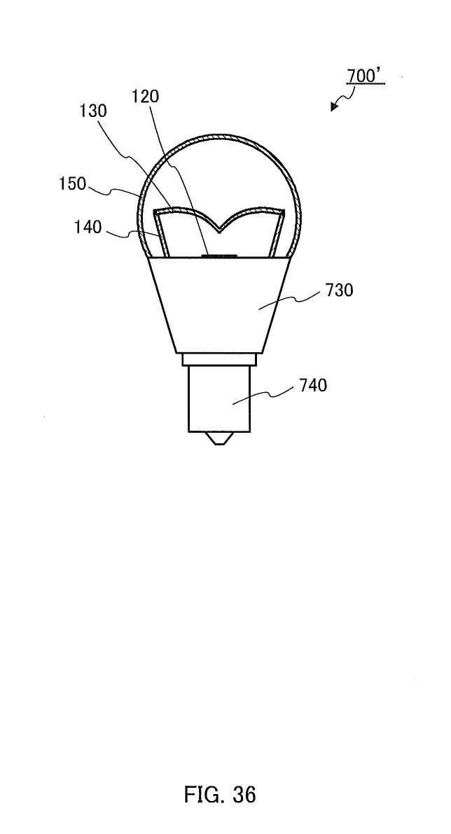

FIG. 36 is a cross-sectional view illustrating bulb-type illumination apparatus 700′ including illumination apparatus 100 according to Embodiment 1. As shown in this figure, as long as the relationship between the size of light flux controlling member 130 and the size of lamp casing 730 is appropriate, light reflected by light flux controlling member 130 in the backward direction can illuminate the surface to be irradiated in the backward direction without being disturbed by lamp casing 730.

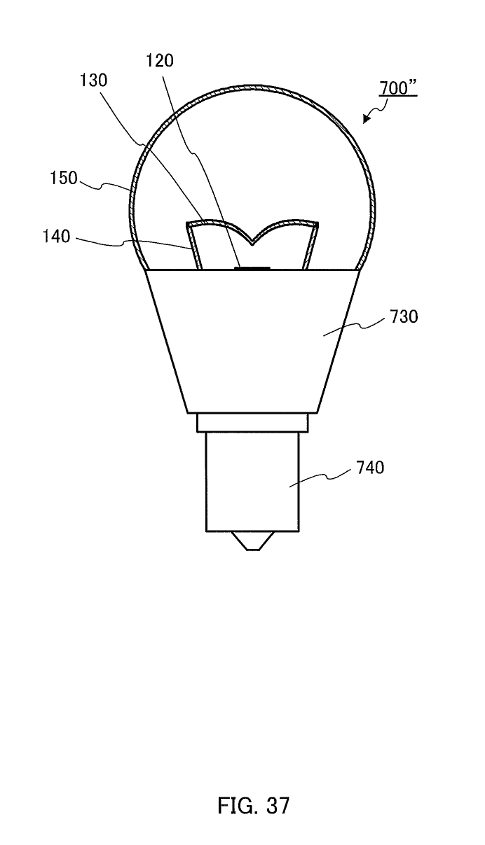

FIG. 37 is a cross-sectional view illustrating bulb-type illumination apparatus 700″ including illumination apparatus 100 according to Embodiment 1. In illumination apparatus 700″ illustrated in FIG. 37, the size of lamp casing 730 is different from illumination apparatus 700′ illustrated in FIG. 36. As shown in this figure, when the relationship between the size of light flux controlling member 130 and the size of lamp casing 730 is not appropriate, light reflected by light flux controlling member 130 in the backward direction may be disturbed by lamp casing 730.

Thus, even when large lamp casing 730 is used, by disposing light emitting element 120, light flux controlling member 130 and sidewall portion 140 above the opening of cover 720, the light reflected by light flux controlling member 130 in the backward direction is less likely to be disturbed by lamp casing 730. Therefore, as illustrated in FIG. 35, in illumination apparatus 700 according to the present embodiment, light emitting element 120, light flux controlling member 130 and sidewall portion 140 are disposed on base 710.

### [Evaluation Test]

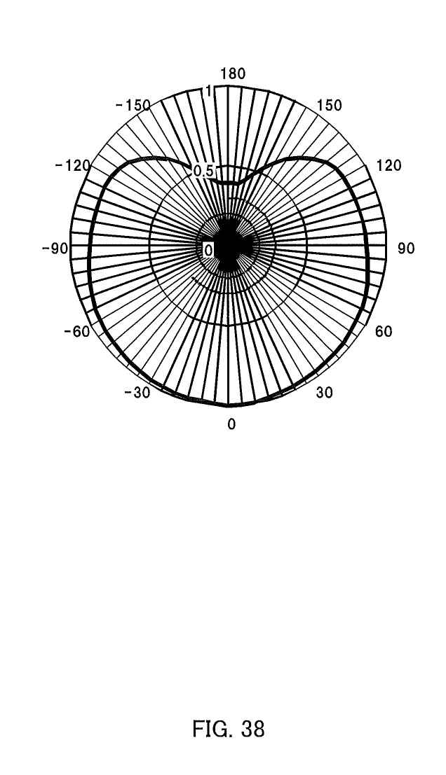

FIG. 38 is a graph illustrating the light distribution characteristics of bulb-type illumination apparatus 700′ including illumination apparatus 100 according to Embodiment 1 illustrated in FIG. 36. The outer diameter of lamp casing 730 is 35 mm and the size of light emitting element 120 is 7.6 mm×6.6 mm. It is understood from this graph that illumination apparatus 700′ illustrated in FIG. 36 has wide and balanced light distribution characteristics.

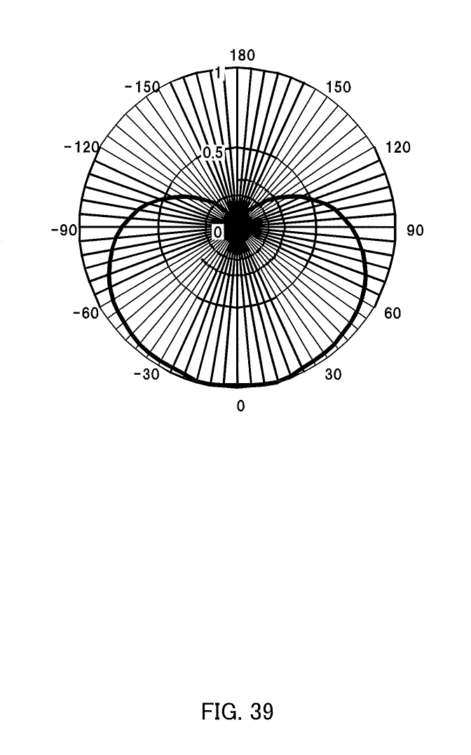

FIG. 39 is a graph illustrating the light distribution characteristics of bulb-type illumination apparatus 700″ including illumination apparatus 100 according to Embodiment 1 illustrated in FIG. 37. The outer diameter of lamp casing 730 is 52.5 mm and the size of light emitting element 120 is 7.6 mm×6.6 mm. It is understood from this graph that it is not possible to sufficiently achieve the light distribution in the backward direction when lamp casing 730 is relatively large as compared with light flux controlling member 130.

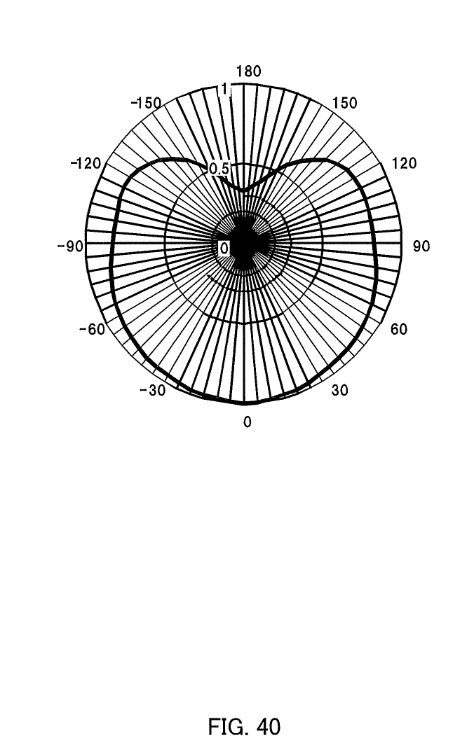

FIG. 40 is a graph illustrating the light distribution characteristics of illumination apparatus 700 according to Embodiment 7 illustrated in FIG. 35. The outer diameter of lamp casing 730 is 52.5 mm, the size of light emitting element 120 is 7.6 mm×6.6 mm and the interval between lamp casing 730 and light emitting element 120 (the height of base 710) is 17 mm. It is understood from this graph that, even in a case where lamp casing 730 is relatively large as compared with light flux controlling member 130, it is possible to sufficiently achieve the light distribution in the backward direction by disposing light emitting element 120, light flux controlling member 130 and sidewall portion 140 above the opening of cover 720.

### [Effect]

When light emitting element 120 and light flux controlling member 130 for a small lamp are applied to a larger lamp as it is, light in the backward direction is disturbed by lamp casing 730 and it is not possible to realize balanced light distribution characteristics (see FIG. 37). Meanwhile, if light flux controlling member 130 is enlarged according to lamp casing 730, the manufacturing cost increases from the viewpoint of the moldability and the formation of a transmissive/reflective coating.

In contrast, in illumination apparatus 700 according to Embodiment 7, by adjusting the height of base 710 according to the outer diameter of lamp casing 730, it is possible to realize balanced light distribution characteristics without changing the size of light flux controlling member 130.

### Embodiment 8

### [Configuration of Illumination Apparatus]

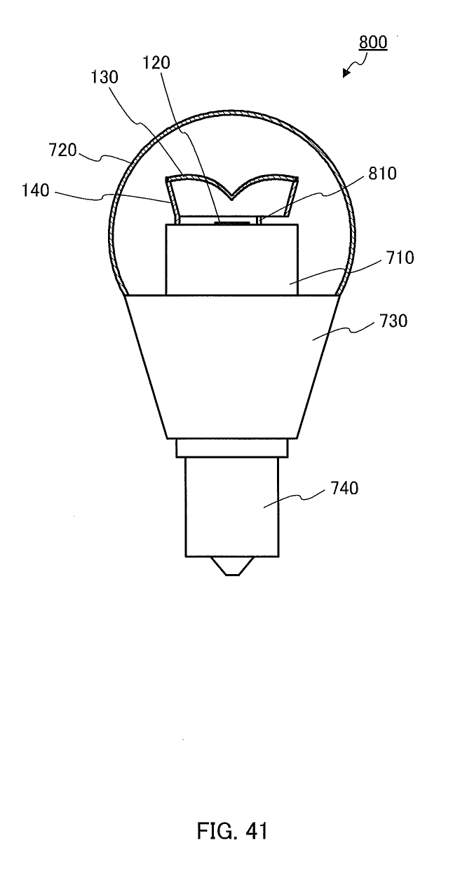

FIG. 41 is a cross-sectional view illustrating the configuration of illumination apparatus 800 according to Embodiment 8 of the present invention. Illumination apparatus 800 according to Embodiment 8 is different from illumination apparatus 700 according to Embodiment 7 in that light flux controlling member 130 and sidewall portion 140 are supported by three leg portions 810.

### [Evaluation Test]

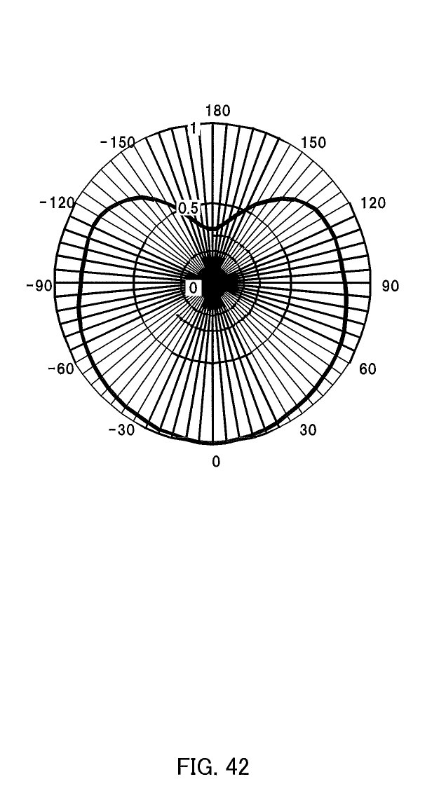

FIG. 42 is a graph illustrating the light distribution characteristics of illumination apparatus 800 according to Embodiment 8. The size of each component is the same as in illumination apparatus 700 according to Embodiment 7. In each cylindrical leg portion 810, the outer diameter is 1 mm and the length is 2 mm. It is understood from this graph that illumination apparatus 800 according to Embodiment 8 has wide and balanced light distribution characteristics.

### [Effect]

An effect of illumination apparatus 800 according to Embodiment 8 is that it is possible to remarkably reduce the space to place light flux controlling member 130 on base 710 in addition to a similar effect to illumination apparatus 100 according to Embodiment 7.

### Embodiment 9

### [Configuration of Illumination Apparatus]

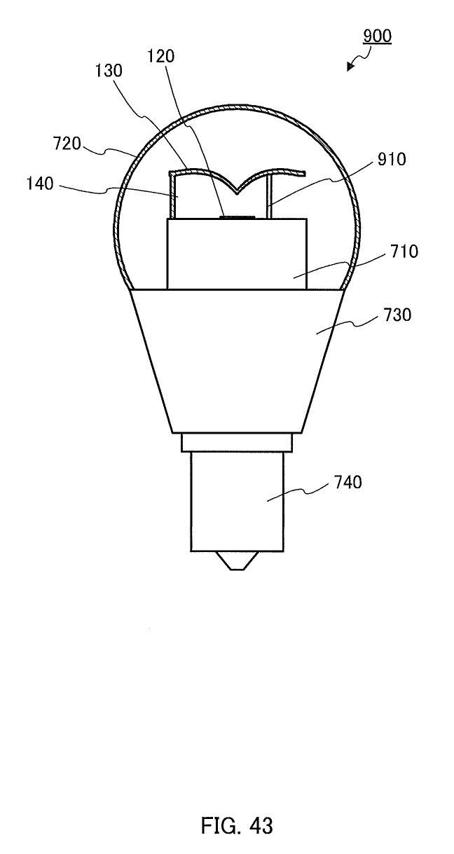

FIG. 43 is a cross-sectional view illustrating the configuration of illumination apparatus 900 according to Embodiment 9 of the present invention. Illumination apparatus 900 according to Embodiment 9 is different from illumination apparatus 700 according to Embodiment 7 in that light flux controlling member 130 is supported by three leg portions 910 instead of the sidewall portion. Light flux controlling member 130 and leg portion 910 may be created integrally or may be created separately.

### [Evaluation Test]

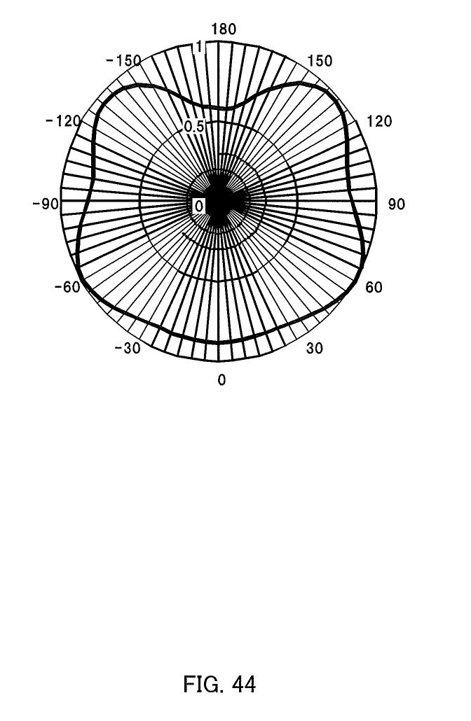

FIG. 44 is a graph illustrating the light distribution characteristics of illumination apparatus 900 according to Embodiment 9. The size of each component is the same as in illumination apparatus 700 according to Embodiment 7. In each cylindrical leg portion 910, the outer diameter is 1 mm and the length is 2 mm It is understood from this graph that illumination apparatus 900 according to Embodiment 9 has wide and balanced light distribution characteristics.

### [Effect]

Illumination apparatus 900 according to Embodiment 9 has the effect similar to illumination apparatus 800 according to Embodiment 8.

### Embodiment 10

### [Configuration of Illumination Apparatus]

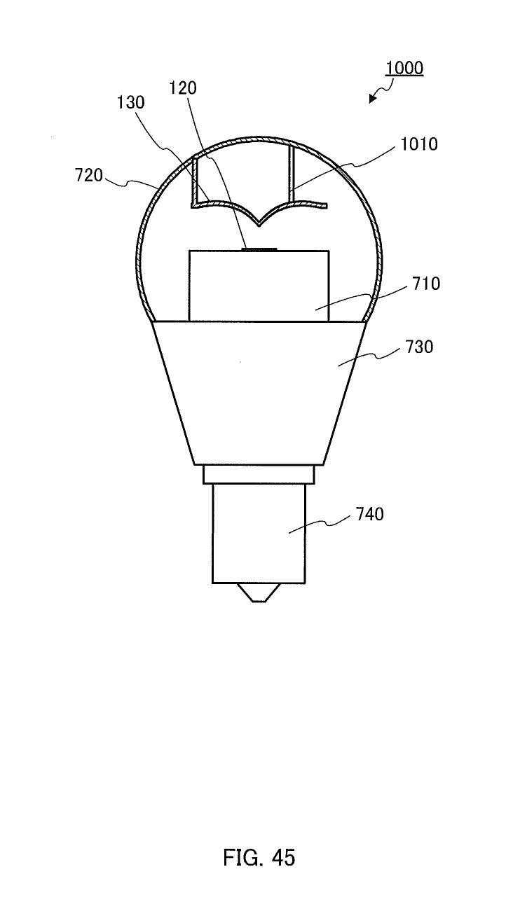

FIG. 45 is a cross-sectional view illustrating the configuration of illumination apparatus 1000 according to Embodiment 10 of the present invention. Illumination apparatus 1000 according to Embodiment 10 is different from illumination apparatus 700 according to Embodiment 7 in that light flux controlling member 130 is supported by three hanging portions 1010 instead of the sidewall. Hanging portion 1010 is fixed to the inner surface of cover 720. Hanging portion 1010 may be created integrally with light flux controlling member 130 or cover 720, or they may be created separately.

### [Evaluation Test]

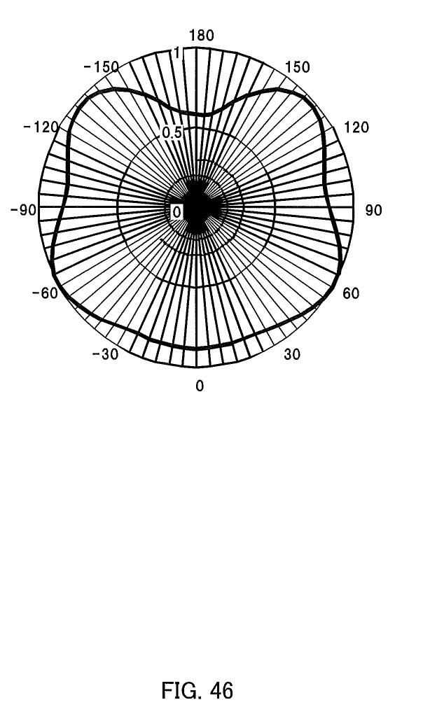

FIG. 46 is a graph illustrating the light distribution characteristics of illumination apparatus 1000 according to Embodiment 10. The size of each component is the same as in illumination apparatus 700 according to Embodiment 7. In each cylindrical hanging portion 1010, the outer diameter is 1 mm and the length is 10.8 mm. It is understood from this graph that illumination apparatus 1000 according to Embodiment 10 has wide and balanced light distribution characteristics.

### [Effect]

An effect of illumination apparatus 1000 according to Embodiment 10 is that the space to place light flux controlling member 130 on base 710 is not necessary, in addition to a similar effect to illumination apparatus 700 according to Embodiment 7.

### Embodiment 11

### [Configuration of Illumination Apparatus]

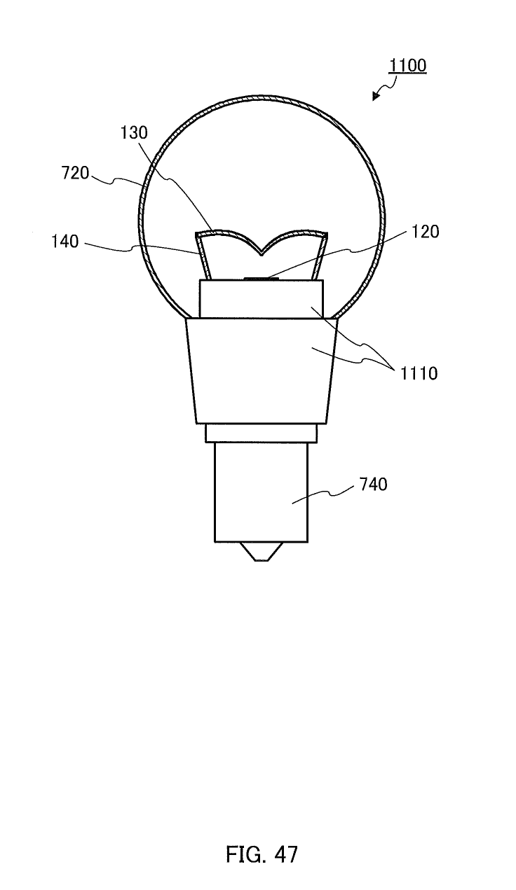

FIG. 47 is a cross-sectional view illustrating the configuration of illumination apparatus 1100 according to Embodiment 11 of the present invention. Illumination apparatus 1100 according to Embodiment 11 is acquired by extending cover 150 by 9.1 mm toward cap 740 (cover 720) and removing part of lamp casing 730 accordingly in illumination apparatus 700″ illustrated in FIG. 37. Specifically, the roles of both base 710 and lamp casing 730 in illumination apparatus 700 according to Embodiment 7 are undertaken by lamp casing 1110.

### [Evaluation Test]

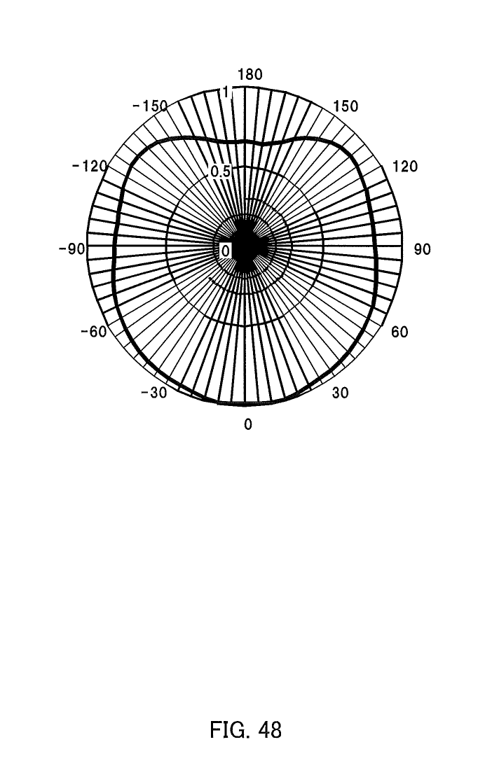

FIG. 48 is a graph illustrating the light distribution characteristics of illumination apparatus 1100 according to Embodiment 11. It is understood from this graph that illumination apparatus 1100 according to Embodiment 11 has wide and balanced light distribution characteristics.

### [Effect]

Illumination apparatus 1100 according to Embodiment 11 has a similar effect to illumination apparatus 700 according to Embodiment 7.

The present application claims the right of priority based on Japanese Patent Application No. 2011-243366, filed on Nov. 7, 2011, the entire content of which including the specification and drawings is herein incorporated by reference.

### INDUSTRIAL APPLICABILITY

The illumination apparatus of the present invention can be used in place of an incandescent lamp and therefore is widely applicable to various kinds of lighting equipment such as a chandelier and an indirect illumination apparatus.

### REFERENCE SIGNS LIST

10, 20 Illumination apparatus
12, 22 LED
14 Cover
16 Aluminum plate
18 Transmissive window
24 Diffusion cover
26 Transparent cover
100, 100′, 200, 300, 400, 500, 600 Illumination apparatus
110, 210, 410, 510, 610 Substrate
120 Light emitting element
130, 130′ 230, 330, 430, 530, 630 Light flux controlling member
132, 132′ 232, 332, 432, 532, 632 Reflection surface
140, 240, 440, 540, 640 Sidewall portion
150, 720 Cover
550 Lid portion
660 Lens
700, 700′, 700″, 800, 900, 1000, 1100 Bulb-type illumination apparatus
710 Base
730, 1110 Lamp casing
740 Cap
810, 910 Leg portion
1010 Hanging portion
CA Central axis of light flux controlling member
LA Optical axis of light emitting element

1. An illumination apparatus comprising:
one or more light emitting elements disposed on a substrate; and
a light flux controlling member that is positioned relative to the light emitting element with air space in between such that an optical axis of the light emitting element and a central axis thereof coincide with each other, reflects part of light emitted from the light emitting element and transmits part of the light, wherein
the light flux controlling member has a reflection surface that faces the light emitting element and reflects part of the light emitted from the light emitting element,
the reflection surface has an aspherical curved surface whose height from the light emitting element increases toward an outer peripheral portion from a center portion, which center portion is an intersection with the optical axis of the light emitting element,
the outer peripheral portion of the reflection surface is formed at a point distant from the light emitting element in a direction of the optical axis of the light emitting element, as compared with a position of the center portion of the reflection surface, and
the reflection surface reflects part of the light emitted from the light emitting element so as to satisfy following Expression 1 when an angle of the light emitted along the optical axis of the light emitting element from the light emitting element is assumed to be 0°:
θ(a2)<θ(b2) (1)
where θ(a2) is an angle of light with respect to the optical axis of the light emitting element, where the light is emitted from a luminescence center of the light emitting element at an angle of θ(a1) with respect to the optical axis of the light emitting element and reflected by the reflection surface;
θ(b2) is an angle of light with respect to the optical axis of the light emitting element, where the light is emitted from the luminescence center of the light emitting element at an angle of θ(b 1) with respect to the optical axis of the light emitting element and reflected by the reflection surface; and
θ(c1)≦θ(a1)<θ(b1) is established when an angle of a line with respect to the optical axis of the light emitting element is assumed to be θ(c1), where the line connects the luminescence center of the light emitting element with a point at which light arrives on the reflection surface, the light being emitted in a direction parallel to the optical axis of the light emitting element from a furthest point from the luminescence center of the light emitting element in the light emitting element.

2. The illumination apparatus according to claim 1, wherein the reflection surface includes a transmissive/reflective coating formed thereon which reflects part of the light emitted from the light emitting element and transmits part of the light.

3. The illumination apparatus according to claim 1, wherein the light flux controlling member is formed of a material that reflects part of the light emitted from the light emitting element and transmits part of the light.

4. The illumination apparatus according to claim 1, wherein the light flux controlling member has a transmissive portion that transmits part of the light emitted from the light emitting element.

5. The illumination apparatus according to claim 4, wherein the transmissive portion is a through-hole or a recess.

6. The illumination apparatus according to any one of claims 1 to 5, further comprising a cover that has a hollow area formed therein with an opening, wherein
the light emitting element and the light flux controlling member are disposed in the hollow area of the cover, and
the cover transmits and diffuses reflected light and transmitted light from the light flux controlling member.

7. The illumination apparatus according to claim 6, wherein the cover is a substantially spherical crown shape.

8. The illumination apparatus according to claim 6, wherein, when an emission direction of the light emitted from the light emitting element along the optical axis is assumed to be positive, the opening of the cover is located in a negative direction of the optical axis as compared with the light emitting element.

9. The illumination apparatus according to claim 6, wherein the light emitting element and the light flux controlling member are located on an opposite side of a maximum outer diameter part of the cover from the opening.

10. An illumination apparatus comprising:
one or more light emitting elements disposed on a substrate; and
a light flux controlling member that is positioned relative to the light emitting element with air space in between such that an optical axis of the light emitting element and a central axis thereof coincide with each other, reflects part of light emitted from the light emitting element and transmits part of the light, wherein
the light flux controlling member has a reflection surface that faces the light emitting element and reflects part of the light emitted from the light emitting element,
the reflection surface has an aspherical curved surface whose height from the light emitting element increases toward an outer peripheral portion from a center portion, which center portion is an intersection with the optical axis of the light emitting element,
the outer peripheral portion of the reflection surface is formed at a point distant from the light emitting element in a direction of the optical axis of the light emitting element, as compared with a position of the center portion of the reflection surface, and
the reflection surface is a rotationally symmetric plane with respect to a central axis of the light flux controlling member and a generating line thereof has a concave shape with respect to light emitting element.
